(19) United States
(12) Patent Application Publication
(10) Pub. No.: US 2023/0403672 A1
(43) Pub. Date: Dec. 14, 2023

(54) WIRELESS CONTROL DEVICE, WIRELESS COMMUNICATION SYSTEM, AND WIRELESS CONTROL METHOD

(71) Applicant: NEC Corporation, Tokyo (JP)

(72) Inventors: Toshiki TAKEUCHI, Tokyo (JP); Kazushi Muraoka, Tokyo (JP)

(73) Assignee: NEC Corporation, Tokyo (JP)

(21) Appl. No.: 17/994,976

(22) Filed: Nov. 28, 2022

Related U.S. Application Data
(60) Provisional application No. 63/351,860, filed on Jun. 14, 2022.

(30) Foreign Application Priority Data
Aug. 23, 2022 (JP) 2022-132838

(51) Int. Cl. H04W 64/00

(52) U.S. Cl. CPC H04W 64/00

(57) ABSTRACT

To provide a wireless control device, a wireless communication system, a wireless control method, and a wireless control program that are able to achieve stable communication quality.

The wireless control device includes: a movement prediction unit configured to predict a movement of a wireless terminal configured to perform wireless communication; a propagation change determination unit configured to determine a propagation change degree indicating a degree of an extent that propagation of the wireless communication including received power of the wireless communication changes within a predetermined assumed delay time; and a selection unit configured to select, from among a plurality of antennas and a plurality of beams, at least any of the antenna and the beam being used for wireless communication control with the wireless terminal, based on the propagation change degree being determined by the propagation change determination unit.

### INCORPORATION BY REFERENCE

This application is based upon and claims the benefit of priority from Japanese patent application No. 2022-132838, filed on Aug. 23, 2022, and U.S. provisional application No. 63/351,860, filed on Jun. 14, 2022, disclosure of which is incorporated herein in its entirety by reference.

### TECHNICAL FIELD

The present disclosure relates to a wireless control device, a wireless communication system, a wireless control method, a wireless control program, and a storage medium that stores the program. For example, the present disclosure relates to a wireless base station device and a wireless communication system, and particularly to a control method for an antenna and a beam in a wireless base station device of a distributed antenna type (distributed MIMO: multiple-input and multiple-output) in a high frequency band.

### BACKGROUND ART

In order to achieve a large capacity of a mobile communication system such as a cellular system, importance of wireless communication using a high frequency band of a millimeter wave, a terahertz wave, and the like that can use a wide frequency bandwidth is increasing. When a high frequency band is used for mobile communication, large capacity communication can be achieved by being able to utilize a wide frequency bandwidth. On the other hand, there are a problem that a propagation loss depending on a frequency is large, and a problem that an influence of a shield is large due to great straightness and great difficulty for a radio wave to go around.

As a means for solving the former problem of a propagation loss, there is a beam forming technique. The beam forming technique is a technique for increasing a reception level of a wireless signal to be transmitted in a direction in which a communication target is present, by performing appropriate phase control on the wireless signal to be transmitted from many antenna elements. By using the beam forming technique, a large propagation loss due to a high frequency band can be compensated.

As a means for solving the latter problem of straightness, there is a distributed antenna system (DAS). The DAS projects an antenna of a wireless base station, distributes and disposes a plurality of antennas, and thus reduces a probability that line-of-sight communication between the antenna and a wireless terminal is shielded.

However, when the wireless terminal and the distributed antenna are shielded therebetween while the wireless terminal is moving, there is a possibility that received power from the distributed antenna may significantly decrease. In that case, the wireless terminal needs to switch to a different beam in a direction in which a reflection wave instead of a direct wave can be received, or switch to transmission from a different distributed antenna located in a line-of-sight position. However, a wireless link disconnection (radio link failure) may occur due to sudden degradation of received power, and connection establishment may be needed by a reconnection procedure. At this time, time in which data communication cannot be performed occurs in the wireless terminal. Meanwhile, in order to prevent occurrence of the radio link failure, the same wireless signal can be always transmitted simultaneously from a plurality of the distributed antennas, but there is a possibility that system throughput may be limited by redundant usage of a wireless resource.

In “A Study of Proactive Beam Forming Control Using Machine Learning for 5G Mobile Communication System”, Takashi Seyama, Teppei Oyama, and Takashi Dateki (IEICE, Technical Report SR2018-7, May 2018), as a method of avoiding inefficient usage of a wireless resource by redundant communication without interrupting a connection of a wireless link, a technique of a wireless control method applying a machine learning technique has been considered. Seyama and others predict an event in which a reception level greatly decreases, by machine learning using time series data of a beam number selected by a wireless terminal and a reception level in a wireless signal from a base station when the beam is used. Since degradation due to a static shield such as a building and a tree has reproducibility, Seyama and others can predict such degradation of a reception level. When degradation of a reception level is predicted, Seyama and others maintain a connection by transmitting a beam as a backup.

Seyama and others can estimate a reception level without being clearly aware of a shield and the like, whereas there is a possibility that an error may be made in beam selection and antenna selection depending on a situation of a wireless terminal. For example, FIG. 1 is a diagram illustrating switching of a beam to a moving wireless terminal. As illustrated in FIG. 1, a wireless terminal 210 is shielded from a base station antenna 110 in a blocking section 310 by a shield 300 due to a movement, and thus a reception level is greatly degraded. On the other hand, a wireless terminal 220 is located in front of the shield 300, and is not thus affected by the shield 300, and a reception level is not affected. However, Seyama and others perform learning, based on a reception level and a beam number, and thus there is a possibility that situations of the wireless terminal 210 and the wireless terminal 220 may be confused. For example, received power of the wireless terminal 210 and the wireless terminal 220 may be about the same depending on a propagation environment, and, in that case, a prediction error in shielding is conceivably more likely to occur.

Published Japanese Translation of PCT International Publication for Patent Application, No. 2020-507233 discloses a technique of performing beam selection according to a position being predicted by using position information about a wireless terminal, further detecting a fixed shield such as a tree, and performing selection of a beam and an antenna according to a detection result. In Published Japanese Translation of PCT International Publication for Patent Application, No. 2020-507233, selection of a beam and an antenna that avoids a shield according to a position can be conceivably achieved by using position information.

However, as in Published Japanese Translation of PCT International Publication for Patent Application, No. 2020-507233, a situation unique to a wireless terminal cannot be reflected only with position information, and selection of an optimum beam and an optimum antenna may be difficult. For example, when selection of a beam and an antenna is performed based on only a predicted position, there is a possibility that the wireless terminal cannot perform communication or a connection may be interrupted in a case where the prediction is wrong. Further, when selection of a plurality of beams and antennas is performed based on both of a current state and a predicted position, there is a possibility that system throughput may be limited by redundant usage of a wireless resource.

Japanese Unexamined Patent Application Publication No. 2019-134217 discloses a technique of setting a group of wireless terminals estimated to be moving by the same transportation means (such as a train) as one wireless terminal group, based on position information about the wireless terminal and speed information about the wireless terminal. Further, in Japanese Unexamined Patent Application Publication No. 2019-134217, a group position of the wireless terminal group after a predetermined time is estimated, and beam forming is performed according to a traveling direction of the wireless terminal group. Furthermore, in Japanese Unexamined Patent Application Publication No. 2019-134217, a classification of a user terminal such as a smartphone and a tablet terminal and a classification of a service terminal of a train are used as classification information about a wireless terminal. The service terminal of the train includes an indoor display terminal installed in the train, a communication terminal being used for operation service of the train, a machine terminal that controls various sensors in the train, and the like.

In Japanese Unexamined Patent Application Publication No. 2019-134217, a coverage of a base station can be adjusted by using a beam suitable for a predicted position to which the wireless terminal group moves. Meanwhile, when an obstacle is located between the base station and the wireless terminal group, there is a possibility that the wireless terminal group may be shielded by the obstacle all at once and a connection may be interrupted.

### SUMMARY

In this way, by Seyama and others, Published Japanese Translation of PCT International Publication for Patent Application, No. 2020-507233, and Japanese Unexamined Patent Application Publication No. 2019-134217 disclose that a position being predicted by using position information about a wireless terminal and a shield are detected, and selection of a beam and an antenna is performed according to the detection. However, selection of an optimum beam and an optimum antenna may be difficult with only the position information. For example, when a predicted beam is selected alone, there is a possibility that the wireless terminal cannot perform communication in a case where the prediction is wrong. Further, when selection of a plurality of beams and antennas is performed based on both of a current state and a predicted position, there is a possibility that system throughput may be limited by redundant usage of a wireless resource. Achievement of stable communication quality is desired.

An example object of the present disclosure has been made in order to solve such a problem and is to provide a wireless control device, a wireless communication system, a wireless control method, and a wireless control program that are able to achieve stable communication quality.

A wireless control device according to one example embodiment includes: a movement prediction unit configured to predict a movement of a wireless terminal configured to perform wireless communication; a propagation change determination unit configured to determine a propagation change degree indicating a degree of an extent that propagation of the wireless communication including received power of the wireless communication changes within a predetermined assumed delay time; and a selection unit configured to select, from among a plurality of antennas and a plurality of beams, at least any of the antenna and the beam being used for wireless communication control with the wireless terminal, based on the propagation change degree being determined by the propagation change determination unit.

A wireless communication system according to one example embodiment includes: at least one wireless terminal; and a wireless control device configured to perform wireless communication with the wireless terminal, wherein the wireless control device includes a movement prediction unit configured to predict a movement of the wireless terminal; a propagation change determination unit configured to determine a propagation change degree indicating a degree of an extent that propagation of the wireless communication including received power of the wireless communication changes within a predetermined assumed delay time; and a selection unit configured to select, from among a plurality of antennas and a plurality of beams, at least any of the antenna and the beam being used for wireless communication control with the wireless terminal, based on the propagation change degree being determined by the propagation change determination unit.

A wireless control method according to one example embodiment includes: predicting a movement of a wireless terminal configured to perform wireless communication; determining a propagation change degree indicating a degree of an extent that propagation of the wireless communication including received power of the wireless communication changes within a predetermined assumed delay time; and selecting, from among a plurality of antennas and a plurality of beams, at least any of the antenna and the beam being used for wireless communication control with the wireless terminal, based on the determined propagation change degree.

A wireless control program and a storage medium storing the program according to one example embodiment cause a computer to execute: predicting a movement of a wireless terminal configured to perform wireless communication; determining a propagation change degree indicating a degree of an extent that propagation of the wireless communication including received power of the wireless communication changes within a predetermined assumed delay time; and selecting, from among a plurality of antennas and a plurality of beams, at least any of the antenna and the beam being used for wireless communication control with the wireless terminal, based on the determined propagation change degree.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating switching of a beam to a moving wireless terminal;

FIG. 2 is a block diagram illustrating a wireless control device according to an overview of an example embodiment;

FIG. 3 is a flowchart diagram illustrating a wireless control method according to the overview of the example embodiment;

FIG. 4 is a diagram illustrating a configuration of a wireless communication system according to a first example embodiment;

FIG. 5 is a block diagram illustrating a wireless base station device in the wireless communication system according to the first example embodiment;

FIG. 6 is a block diagram illustrating an antenna/beam prediction control unit in the wireless base station device according to the first example embodiment;

FIG. 7 is a block diagram illustrating a propagation change determination unit according to the first example embodiment;

FIG. 8 is a graph illustrating delay time information being a reference in the propagation change determination unit according to the first example embodiment, and illustrates timings of a reference interval of received power information, control such as candidate beam selection and a communication beam decision, and communication at a decided communication beam;

FIG. 9 is a diagram illustrating a Fresnel zone and a Fresnel radius in the propagation change determination unit according to the first example embodiment;

FIG. 10A is a graph illustrating a change in propagation (wireless quality) according to the first example embodiment, and a horizontal axis indicates time and a vertical axis indicates propagation (wireless quality) of wireless communication;

FIG. 10B is a graph illustrating a change in propagation (wireless quality) according to the first example embodiment, and a horizontal axis indicates time and a vertical axis indicates propagation (wireless quality) of wireless communication;

FIG. 11A is a diagram illustrating received power of a current beam and a selected beam according to the first example embodiment;

FIG. 11B is a diagram illustrating received power of a current beam and a selected beam according to the first example embodiment;

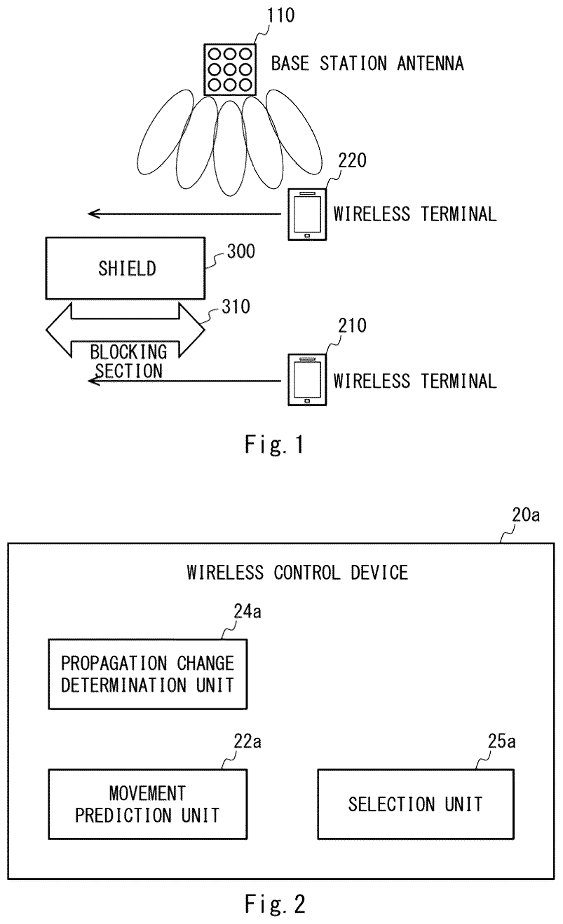

FIG. 1C is a diagram illustrating received power of a current beam and a selected beam according to the first example embodiment;

FIG. 12 is a flowchart diagram illustrating a prediction control method in the antenna/beam prediction control unit according to the first example embodiment;

FIG. 13 is a flowchart diagram illustrating a prediction control method in the propagation change determination unit and a selection unit according to the first example embodiment; and

FIG. 14 is a block diagram illustrating a case where the wireless control device according to the first example embodiment and a second example embodiment is achieved by an information processing device.

### EXAMPLE EMBODIMENT

Hereinafter, example embodiments will be described with reference to drawings. For clarification of the description, the description and the drawings below are appropriately omitted and simplified. Further, in each of the drawings, the same elements will be denoted by the same reference signs, and duplicate description will be omitted as necessary.

### OVERVIEW OF EXAMPLE EMBODIMENT

First, a wireless control device according to an overview of an example embodiment will be described. Note that it is assumed that the wireless control device includes several devices described below such as a wireless base station device. The present example embodiment has been made in order to solve the problem described above, and is to provide, for example, the wireless base station device, a wireless communication system, and the like that achieve stable communication quality with a minimum necessary amount of a wireless resource. In order to solve such a problem, the present example embodiment includes the following characteristic.

The wireless base station device predicts a position to which a wireless terminal moves after an assumed delay time, and also estimates a movement speed of the wireless terminal. Further, the wireless base station device estimates a reception level of a wireless signal for each antenna and each beam in the predicted position, and calculates a propagation change degree indicating a degree of an extent that propagation of wireless communication changes within the assumed delay time by using the movement speed. Then, the wireless base station device decides, by also using the propagation change degree, at least any of an antenna and a beam to be used for the wireless communication with the wireless terminal.

By the means described above, the wireless base station device has the following effects, for example. In other words, the wireless base station device according to the present example embodiment calculates a propagation change degree, determines necessity of selection control of an antenna and a beam in a predicted position, based on the propagation change degree, and then performs selection of the antenna and the beam to be used for wireless communication. In this way, the wireless base station device can achieve stable communication quality with a minimum necessary amount of a wireless resource.

Further, when selection of a plurality of beams and antennas is performed based on both of a current state and a predicted position, there is a possibility that system throughput may be limited by redundant usage of a wireless resource.

Thus, the wireless base station device according to the present example embodiment calculates an extent that propagation changes within an assumed delay time.

In a case of a great propagation change degree, when blocking occurs due to a movement, great communication quality degradation is concerned. Thus, the wireless base station device predicts a movement of a wireless terminal, and performs selection control of at least any of an antenna and a beam, based on a predicted position.

In a case of a small propagation change degree, even when blocking occurs, great communication quality degradation is not concerned. Thus, in the wireless base station device, selection control of an antenna and a beam based on a predicted position is unnecessary, and selection control of an antenna and a beam based on information about received power currently during communication is performed.

The propagation change degree is calculated from a relationship between an assumed delay time (control delay) and a wireless quality fluctuation time. Herein, the wireless quality fluctuation time is calculated from a radio wave line-of-sight space (Fresnel zone) based on a position of a wireless terminal and the like, for example, and information about a movement speed of the wireless terminal.

In this way, in the overview of the present disclosure, a position and a movement speed in which the wireless terminal moves are predicted, and propagation change degree information about whether propagation of wireless communication changes within an assumed delay time is calculated based on the movement speed. An antenna and a beam to be used for the communication with the wireless terminal are decided by also using the propagation change degree information.

Hereinafter, the wireless control device according to the overview of the present example embodiment will be described with reference to FIG. 2. FIG. 2 is a block diagram illustrating the wireless control device according to the overview of the example embodiment. As illustrated in FIG. 2, a wireless control device 20a includes a movement prediction unit 22a, a propagation change determination unit 24a, and a selection unit 25a. The movement prediction unit 22a, the propagation change determination unit 24a, and the selection unit 25a have a function as a movement prediction means, a propagation change determination means, and a selection means, respectively.

The movement prediction unit 22a performs a prediction about a movement of a wireless terminal configured to perform wireless communication. The propagation change determination unit 24a determines a propagation change degree indicating an extent that propagation including received power of the wireless communication changes within a predetermined assumed delay time. The selection unit 25a selects at least any of an antenna and a beam used for wireless communication control with the wireless terminal, based on the propagation change degree being determined by the propagation change determination unit 24a.

Herein, the propagation change determination unit 24a may determine a propagation change degree from a relationship between an assumed delay time and a quality fluctuation time of the wireless communication. Further, the propagation change determination unit 24a may determine a propagation change degree from a relationship among an assumed delay time for each wireless terminal, information indicating a line-of-sight space of a radio wave used for the wireless communication, and predicted movement information about the wireless terminal.

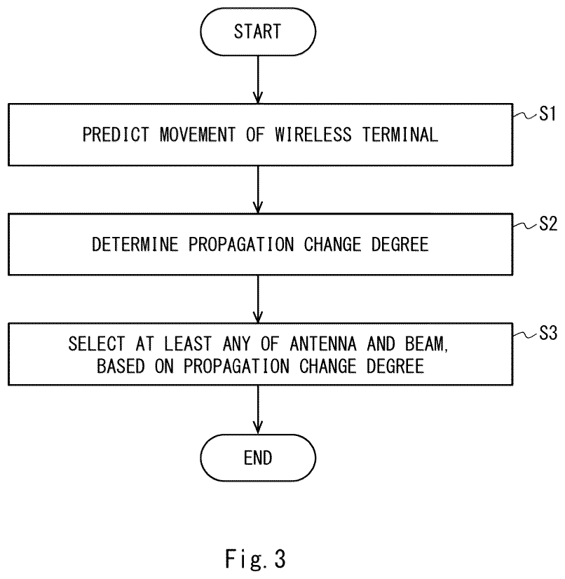

FIG. 3 is a flowchart diagram illustrating a wireless control method according to the overview of the example embodiment. As illustrated in step S1 in FIG. 3, a movement of a wireless terminal is predicted. Specifically, the movement prediction unit 22a performs a prediction about a movement of a wireless terminal configured to perform wireless communication. Next, as illustrated in step S2, a propagation change degree is determined. For example, the propagation change determination unit 24a determines a propagation change degree indicating an extent that propagation including received power of the wireless communication changes within a predetermined assumed delay time. Next, as illustrated in step S3, at least any of an antenna and a beam is selected based on the propagation change degree. Specifically, the selection unit 25a selects at least any of an antenna and a beam used for wireless communication control with the wireless terminal, based on the determined propagation change degree. In this way, the wireless communication can be controlled.

In this way, the wireless control device 20a according to the present example embodiment determines, by calculating a propagation change degree, whether it is necessary to add an antenna and a beam in a predicted position of a wireless terminal. The propagation change degree is calculated from a relationship between an assumed delay time for each wireless terminal and a wireless quality fluctuation time for each wireless terminal. Thus, the wireless control device 20a according to the overview of the present example embodiment determines, by using a propagation change degree, whether selection control of an antenna and a beam in a predicted position is necessary, and then performs selection of the antenna and the beam to be used for wireless communication. In this way, stable communication quality can be achieved with a minimum necessary amount of a wireless resource.

### First Example Embodiment

Next, a wireless communication system and a wireless base station device will be described as an example of a wireless control device according to the first example embodiment. Hereinafter, <Configuration: System>, <Configuration: Wireless Base Station Device>, <Configuration: Antenna/beam Prediction Control Unit>, <Configuration: Position Estimation Unit>, <Configuration: Movement Prediction Unit>, <Configuration: Propagation Information Database>, <Configuration: Propagation Change Degree Determination Unit>, and <Configuration: Selection Unit> will be described with reference to the drawings. Then, <Prediction Control Method for Antenna and Beam> and <Effect> will be described.

### <Configuration: System>

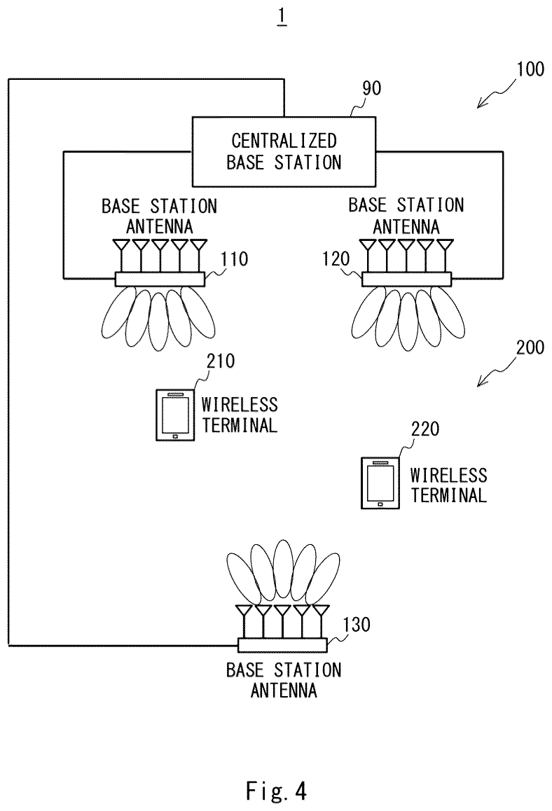

FIG. 4 is a diagram illustrating a configuration of the wireless communication system according to the first example embodiment. As illustrated in FIG. 4, a wireless communication system 1 includes a wireless base station device 100 and wireless terminals 210 and 220. The wireless base station device 100 includes a centralized base station 90 and a plurality of base station antennas 110 to 130. In the present example embodiment, the wireless base station device 100 or the centralized base station 90 includes the wireless control device. A control device such as the wireless base station device 100 or the centralized base station 90 performs wireless communication with the wireless terminals 210 and 220.

The plurality of base station antennas 110 to 130 are disposed in a distributed manner. Each of the base station antennas 110 to 130 can each output a plurality of beams. Note that FIG. 4 illustrates the three base station antennas 110 to 130, but the number of the base station antennas 110 to 130 is not limited to there, and may be two, or four or more. The base station antennas 110 to 130 are collectively referred to as the base station antenna 110 and the like.

Further, FIG. 4 illustrates the two wireless terminals 210 and 220, but the number of the wireless terminals 210 and 220 may be at least one, or may be three or more. The wireless terminals 210 and 220 are collectively referred to as a wireless terminal 200. The wireless terminal 200 is, for example, a portable terminal device such as a smartphone, a tablet, and a notebook computer.

Further, the wireless terminal 200 may be a wearable device having a communication function, an information terminal such as augmented reality (AR) and virtual reality (VR) glasses, game equipment, a camera, an automobile, an automated guided vehicle (AGV), and industrial equipment such as a robot.

The wireless communication system 1 transmits and receives a wireless signal between the base station antennas 110 to 130 connected to the centralized base station 90 in the wireless base station device 100, and the wireless terminal 200.

### <Configuration: Wireless Base Station Device>

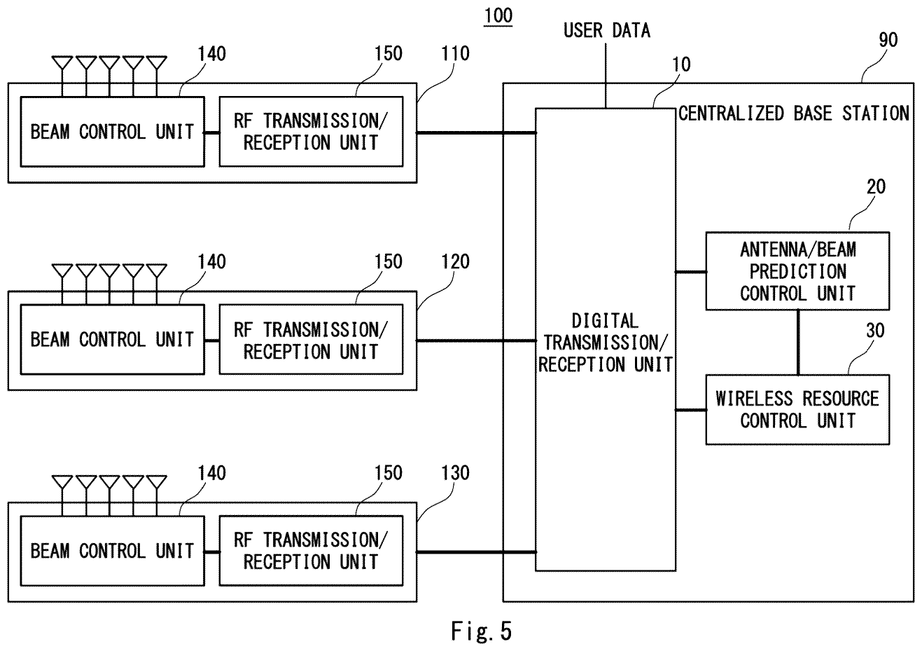

FIG. 5 is a block diagram illustrating the wireless base station device 100 in the wireless communication system 1 according to the first example embodiment. As illustrated in FIG. 5, the base station antenna 110 and the like include a beam control unit 140, a radio frequency (RF) transmission/reception unit 150, and a plurality of antenna elements. The beam control unit 140 and the RF transmission/reception unit 150 have a function as a beam control means and an RF transmission/reception means, respectively. The centralized base station 90 includes a digital transmission/reception unit 10, an antenna/beam prediction control unit 20, and a wireless resource control unit 30. The digital transmission/reception unit 10, the antenna/beam prediction control unit 20, and the wireless resource control unit 30 have a function as a digital transmission/reception means, an antenna/beam prediction control means, and a wireless resource control means, respectively.

The beam control unit 140 of the base station antenna 110 and the like is connected to the plurality of antenna elements. The beam control unit 140 adjusts a phase and an amplitude of a wireless signal for the plurality of antenna elements, and thus decides a direction of a beam. A specific direction, a specific beam number, or the like of a beam is specified by the wireless resource control unit 30. As a means of beam forming, a means other than an array antenna can also be applied. For example, beam forming using a directional antenna such as a lens antenna and a metamaterial antenna may be used.

The RF transmission/reception unit 150 includes an amplifier, a frequency converter, and the like. The RF transmission/reception unit 150 performs transmission and reception of an RF signal.

The digital transmission reception unit 10 performs modulation, demodulation, and the like on user data. For example, processing such as generation of a wireless signal such as orthogonal frequency division multiplexing (OFDM) transmission of a downlink, and demodulation (MIMO signal detection) of an uplink wireless signal being received in many antennas is performed. A radio over fiber (RoF) technique, a common public radio interface (CPRI) technique, an evolved CPRI (eCPRI) technique, and the like are used between the digital transmission/reception unit 10 and the RF transmission/reception unit 150, and a function may be accordingly changed.

The antenna/beam prediction control unit 20 predicts at least any of an antenna and a beam to be used for the wireless communication with the wireless terminal 200. Specifically, the antenna/beam prediction control unit 20 estimates position information about the wireless terminal 200 and predicts a position to which the wireless terminal 200 moves after an assumed delay time, based on the position information, and estimates a reception level of a wireless signal for each antenna and each beam in the predicted position. Furthermore, the antenna/beam prediction control unit 20 estimates a movement speed of the wireless terminal 200, and calculates, based on the estimated movement speed, a propagation change degree indicating an extent that propagation changes within the assumed delay time. Then, the antenna/beam prediction control unit 20 decides, by using the propagation change degree, at least any of an antenna and a beam to be used for the communication with the wireless terminal 200. A more specific operation will be described below.

The wireless resource control unit 30 specifically decides a wireless resource (such as an antenna, a beam, a frequency, and a time) used for each wireless terminal 200, based on the information decided by the antenna/beam prediction control unit 20. The wireless resource control unit 30 is also referred to as a scheduler unit.

### <Configuration: Antenna/beam Prediction Control Unit>

The antenna/beam prediction control unit 20 according to the present example embodiment selects an antenna and a beam, based on propagation information about a wireless signal for each antenna and each beam in a predicted position. However, whether selection control of an antenna and a beam is necessary is controlled after a propagation change degree is calculated by using a movement speed. The propagation change degree is acquired from a relationship between an assumed delay time for each wireless terminal 200 and a wireless quality fluctuation time for each wireless terminal 200.

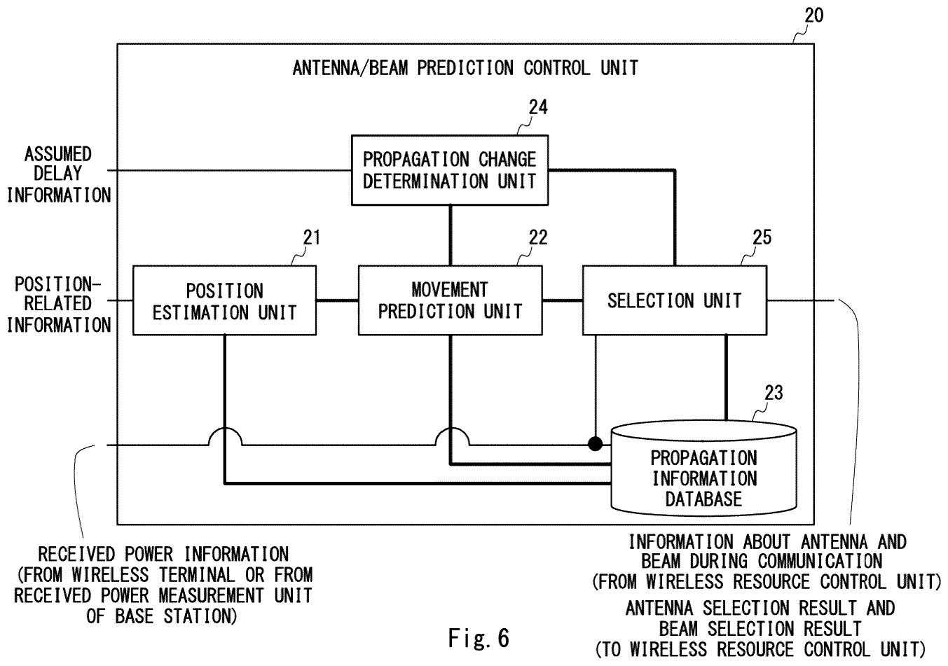

FIG. 6 is a block diagram illustrating the antenna/beam prediction control unit 20 in the wireless base station device 100 according to the first example embodiment. As illustrated in FIG. 6, the antenna/beam prediction control unit 20 includes a position estimation unit 21, a movement prediction unit 22, a propagation information database 23, a propagation change determination unit 24, and a selection unit 25. The position estimation unit 21, the movement prediction unit 22, the propagation information database 23, the propagation change determination unit 24, and the selection unit 25 have a function as a position estimation means, a movement prediction means, a propagation information storage means, a propagation change determination means, and a selection means, respectively. Note that, as described below, any of the configurations of the antenna/beam prediction control unit 20 may be provided in an external device. Particularly, the propagation information database 23 may be provided in an external device or on a cloud.

### <Configuration: Position Estimation Unit>

The position estimation unit 21 estimates a position of the wireless terminal 200 from input position-related information. Any of the following methods can be applied to a method for position estimation of the wireless terminal 200 in the position estimation unit 21.

A first method for position estimation of the wireless terminal 200 uses a wireless signal of the wireless communication system 1. The position estimation unit 21 achieves position estimation of the wireless terminal 200 by using a direction (azimuth) of a beam of a connected single antenna and ranging. Furthermore, as a method for ranging, there are a method for calculation from propagation time such as Round Trip Time, and a method of calculating a distance from a reception level, based on a propagation model. Furthermore, three-point positioning using a plurality of antennas may be used. Further, a difference in propagation time between the plurality of antennas may be used. Further, a position may be estimated by associating information about a reception level of the plurality of antennas with position information. Further, the plurality of methods may be used in a hierarchical manner. For example, a general position may be estimated by a direction of a beam and ranging, and a detailed position in the general position may be estimated from information about a reception level of the plurality of antennas.

In this way, the position estimation unit 21 may estimate a position of the wireless terminal 200, based on at least any of propagation information, information about received power, and arrival time information about a radio wave. The propagation information includes a direction of a beam propagating from the antenna described above and a distance. The information about received power includes information about a reception level of the plurality of antennas.

A second method for position estimation of the wireless terminal 200 is a method of deciding a position by using external information such as a Global Positioning System (GPS). A sensor (such as an accelerometer) other than the GPS may be used. Alternatively, position information about the wireless terminal 200 may be directly acquired from the outside.

### <Configuration: Movement Prediction Unit>

The movement prediction unit 22 predicts a movement of the wireless terminal 200. Any of the following methods can be applied to a method for a movement prediction in the movement prediction unit 22.

A first movement prediction method predicts, from time series of position information about the wireless terminal 200, a position, a movement speed, and a direction after a predetermined time by performing interpolation (for example, linear interpolation) by extrapolation. Further, a prediction may be performed from time series of position information by linear (primary) and curvilinear (higher-order) regression.

A second movement prediction method predicts a position, a movement speed, and a direction of the wireless terminal 200, based on information about a past movement history of the wireless terminal 200. A model of a movement direction and a movement speed is generated by using time series of past position information about the wireless terminal 200. A movement prediction of the wireless terminal 200 is performed by using this model. Further, map information in which information about a sidewalk, a road, a passage, and a railroad can be used may be used for generation of the model described above.

Further, the model described above may be generated by learning by using information about a past movement history of the wireless terminal 200.

In this way, the movement prediction unit 22 predicts a position, a movement speed, and a direction of the wireless terminal 200, based on information about at least any of time series of position information about the wireless terminal 200, a movement history of the wireless terminal 200, and a map around the wireless terminal 200.

Further, a predicted position may be smoothed by using at least any of movement average processing and various filters (such as a Kalman filter and a particle filter).

### <Configuration: Propagation Information Database (Propagation Information Storage Unit)>

The propagation information database 23 receives and records received power information, beam information, and antenna information about a wireless signal from the base station antenna 110 and the like being measured in the wireless terminal 200. The propagation information database 23 stores, as propagation information, information about received power being input from the wireless terminal 200 or a received power measurement unit of a base station. Herein, for a measurement result of received power in the wireless terminal 200, the wireless terminal 200 reports a measurement result of a synchronization signal and a reference signal to the base station antenna 110 and the like. The synchronization signal includes, for example, a primary synchronization signal (PSS) and a secondary synchronization signal (SSS) of NR. The reference signal includes, for example, a physical broadcast channel-demodulation reference signal (PBCH-DMRS) and a channel state information-reference signal (CSI-RS) of NR.

When beam forming is used, each synchronization signal and each reference signal is beam-transmitted, and thus the propagation information database 23 also receives and records measured beam information (such as a beam number). Further, when information about the connected base station antenna 110 and the like can be acquired on the wireless terminal 200 side, the information is reported from the wireless terminal 200 to the propagation information database 23. Since the beam information and the antenna information have a value being set on the base station antenna 110 and the like side, the propagation information database 23 may acquire the information from the inside of the base station antenna 110 and the like.

The propagation information database 23 receives and records received power information, beam information, and antenna information about the base station antenna 110 and the like in addition to or separately from the description above. A measurement of received power in the base station antenna 110 and the like may be performed by using a reference signal being transmitted from the wireless terminal 200. The reference signal includes, for example, a sounding reference signal (SRS), a demodulation reference signal (DMRS), and the like. The propagation information database 23 records information about a reception beam, antenna information, and the like in the base station antenna 110 and the like being used for receiving the reference signal.

Furthermore, the propagation information database 23 receives and records position information about the wireless terminal 200 from the position estimation unit 21. The position information may be managed by coordinate information such as latitude and longitude, or may be managed by a grid number when an area is divided into grids.

The propagation information database 23 may not record all information in the above-described information (such as received power, beam information, antenna information, and a position) about the wireless terminal 200, and may record only a representative value such as an average value and a median value. Alternatively, the propagation information database 23 may reduce an information amount by discarding a past value. The propagation information database 23 may manage position information by coordinate information such as latitude and longitude, or may manage position information by a grid number when an area is divided into grids.

### <Configuration: Propagation Change Determination Unit>

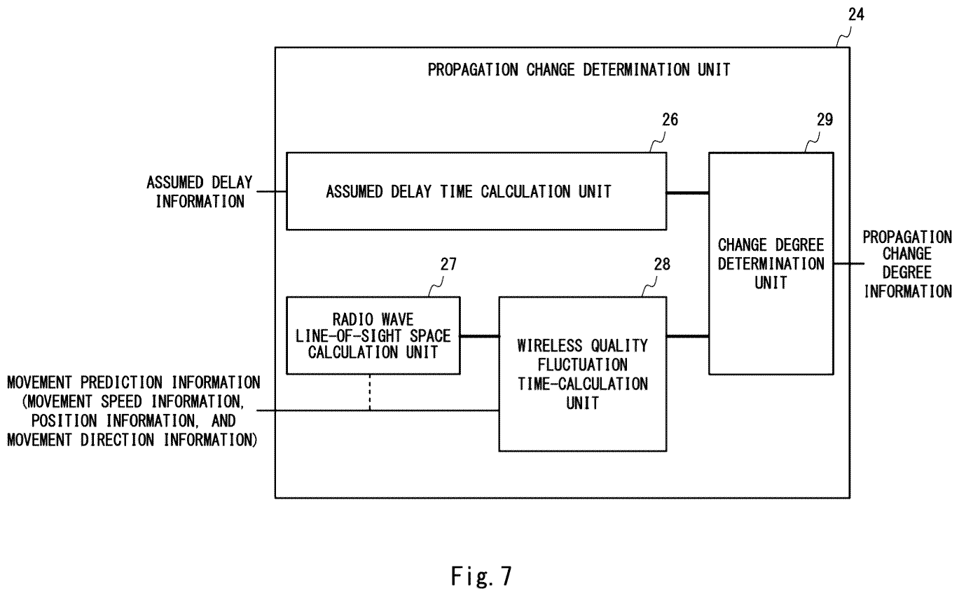

FIG. 7 is a block diagram illustrating the propagation change determination unit 24 according to the first example embodiment. As illustrated in FIG. 7, the propagation change determination unit 24 includes an assumed delay time calculation unit 26, a radio wave line-of-sight space calculation unit 27, a wireless quality fluctuation time-calculation unit 28, and a change degree determination unit 29. The assumed delay time calculation unit 26, the radio wave line-of-sight space calculation unit 27, the wireless quality fluctuation time-calculation unit 28, and the change degree determination unit 29 have a function as an assumed delay time calculation means, a radio wave line-of-sight space calculation means, a wireless quality fluctuation time-calculation means, and a change degree determination means, respectively.

The assumed delay time calculation unit 26 calculates an assumed delay time from assumed delay information. The radio wave line-of-sight space calculation unit 27 calculates a radio wave line-of-sight space from movement prediction information including movement speed information, position information, and movement direction information. The wireless quality fluctuation time-calculation unit 28 calculates a wireless quality fluctuation time from the movement prediction information and the radio wave line-of-sight space. The change degree determination unit 29 calculates a propagation change degree from the assumed delay time and the wireless quality fluctuation time.

With such a configuration, the propagation change determination unit 24 calculates propagation change degree information by using the assumed delay information and the movement prediction information. Note that the propagation change degree information is used for determination of whether at least any of antenna addition, antenna switching, beam addition, and beam switching is necessary, and the like.

The propagation change degree information is calculated from a relationship between 1. an assumed delay time for each wireless terminal 200 and 2. a wireless quality fluctuation time for each wireless terminal 200.

1. The assumed delay time is a time from a timing at which received power information is received to a timing at which an antenna and a beam being selected based on the received power information are effective. It can be said that the assumed delay time is a time from a first timing at which information about the received power is received to a second timing at which the assumed delay time is updated in accordance with information about the received power being received next.

2. The wireless quality fluctuation time is a time required until wireless quality including received power decreases to equal to or less than a predetermined threshold value when a radio wave used for wireless communication is blocked by a shield. Then, when the assumed delay time is longer than the wireless quality fluctuation time, there is a possibility that the wireless quality may extremely decrease due to a shield during communication by a selected antenna and a selected beam. On the other hand, when the assumed delay time is sufficiently shorter than the wireless quality fluctuation time, even with a shield during communication by a selected antenna and a selected beam, updating to an antenna and a beam being selected next can be performed. In other words, it means that updating to an antenna and a beam being selected based on received power information being received next can be achieved while a part of the wireless quality during communication decreases. Herein, the relationship may be a “ratio (proportion)”, or may be a “difference (comparison of magnitude)”.

Hereinafter, 1. an assumed delay time for each wireless terminal 200 and 2. a wireless quality fluctuation time for each wireless terminal 200 will be described with reference to the drawings.

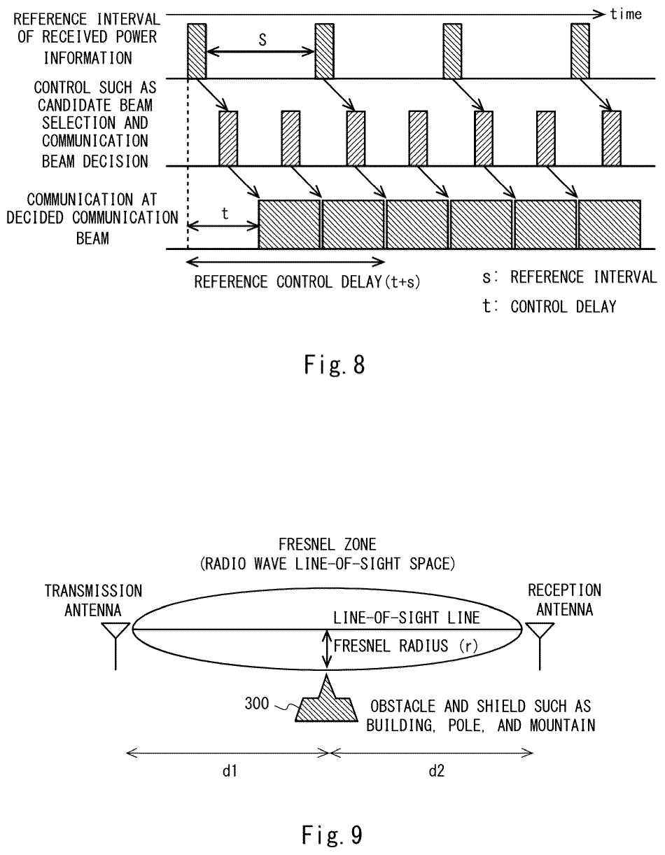

FIG. 8 is a graph illustrating delay time information being a reference in the propagation change determination unit 24 according to the first example embodiment, and illustrates timings of a reference interval of received power information, control such as candidate beam selection and a communication beam decision, and communication at a decided communication beam.

As illustrated in FIG. 8, an assumed delay time for each wireless terminal 200 is calculated by using assumed delay information from the wireless resource control unit 30 as an example. The assumed delay information includes delay time information being a reference based on a reference acquisition interval, a control delay, and the like of received power information to be needed. Further, the assumed delay time may include information about an assigned interval for each wireless terminal 200. In this case, the assumed delay time for each wireless terminal 200 may be calculated by multiplying a part of the delay time information being a reference by assigned interval information for each wireless terminal 200. In a case of FIG. 8, an assumed delay time of the wireless terminal 200 at an assigned interval=2 is (t+2s) and the like.

FIG. 9 is a diagram illustrating a Fresnel zone and a Fresnel radius in the propagation change determination unit 24 according to the first example embodiment. As illustrated in FIG. 9, a wireless quality fluctuation time for each wireless terminal 200 is calculated by using movement speed information for each wireless terminal 200. For example, a wireless quality fluctuation time for each wireless terminal 200 is calculated from a width of a radio wave line-of-sight space (for example, a Fresnel radius or diameter in a Fresnel zone, and the like) and time at which the wireless terminal 200 passes.

Herein, the width of the radio wave line-of-sight space may be fixedly set based on a usage frequency and the like of the wireless communication system 1. Further, the width of the radio wave line-of-sight space may be calculated by a calculation equation of a Fresnel radius or diameter and the like, based on an interval between antennas, a distance between an antenna closest to the wireless terminal 200 and the wireless terminal 200, and the like, by using position information about the wireless terminal 200 and position information about an installed antenna.

For example, a Fresnel radius r (meter, hereinafter indicated as m) when a distance between a transmission antenna of the wireless terminal 200 and a shield 300 is d1 (m), a distance between a reception antenna of the base station antenna 110 and the like and the shield 300 is d2 (m), and a usage frequency is f (Megahertz, hereinafter indicated as Mhz) is the following equation (1).

r=√[(300/f)×{(d1×d2)/(d1+d2)}] (1)

Note that a symbol “/” in the equation (1) represents division.

In other words, the width of the radio wave line-of-sight space may include the Fresnel radius in the Fresnel zone around the shield 300 as the center. Furthermore, the width of the radio wave line-of-sight space may be calculated from the Fresnel radius or diameter and the like after a movement angle of the wireless terminal 200 with respect to an antenna is estimated by using information about a movement direction of the wireless terminal 200. Note that a distance to the shield 300 is decided by an assumed wireless environment (for example, in a case of an environment in which the wireless terminal 200 moves near the shield 300, a value such as 50 (centimeter, hereinafter indicated as cm) and 1 (m) is assumed, which is not limited thereto).

Then, the wireless quality fluctuation time is calculated as a time required for a passage from the width of the radio wave line-of-sight space for each wireless terminal 200 being calculated as described above and movement speed information for each wireless terminal 200 being estimated in the movement prediction unit 22. For example, the wireless quality fluctuation time is calculated by dividing the width of the radio wave line-of-sight space by a movement speed for each wireless terminal 200. The wireless quality fluctuation time is a time required until wireless quality decreases when a radio wave is blocked by the shield 300 such as an obstacle.

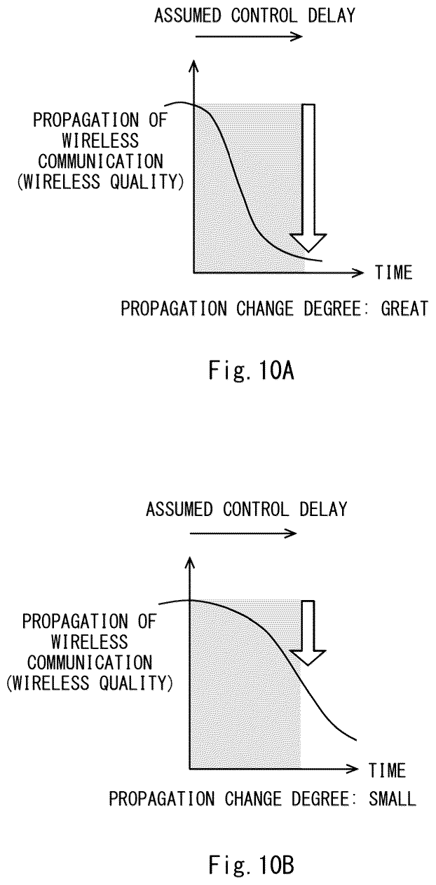

Lastly, propagation change degree information is calculated from a relationship between the assumed delay time for each wireless terminal 200 and the wireless quality fluctuation time. FIGS. 10A and 10B are graphs illustrating a change in propagation (wireless quality) according to the first example embodiment, and a horizontal axis indicates time and a vertical axis indicates propagation (wireless quality) of wireless communication. A propagation change degree indicated by the graph in FIG. 10A is great, and a propagation change degree indicated by the graph in FIG. 10B is small. The change degree determination unit 29 calculates such a propagation change degree. For a calculation method, any of the following methods have no problem.

As a first method, for example, a propagation change degree is calculated from a ratio (proportion) of the assumed delay time for each wireless terminal 200 to the wireless quality fluctuation time for each wireless terminal 200. Then, a value of the ratio (proportion) is output as the propagation change degree information. Note that, when a value of the ratio (proportion) is equal to or more than 1, it means that the assumed delay time is longer. In this case, when being shielded by the shield 300 during the assumed delay time in a state of an antenna and a beam during communication as they are, there is a possibility that wireless communication quality may greatly decrease (FIG. 10A). Thus, the propagation change determination unit 24 (or the selection unit 25) determines selection control of an antenna and a beam in a predicted position as “necessary (effective)”.

On the other hand, when a value of the ratio (proportion) is less than 1, it means that the wireless quality fluctuation time is longer. In this case, even when being shielded by the shield 300 in a state of an antenna and a beam during communication as they are, updating of an antenna and a beam based on next received power information can be achieved before wireless communication quality greatly decreases (FIG. 10B). Thus, the propagation change determination unit 24 (or the selection unit 25) determines selection control of an antenna and a beam in a predicted position as “unnecessary (ineffective)”. The determination is performed by the change degree determination unit 29 in the propagation change determination unit 24, but may be performed by the selection unit 25.

As a second method, for example, a propagation change degree is calculated from a difference (comparison of magnitude) between the assumed delay time for each wireless terminal 200 and the wireless quality fluctuation time for each wireless terminal 200. Then, a value of the difference (comparison of magnitude) is output as the propagation change degree information. Note that, when a value of the difference is positive (equal to or more than 0), it means that the assumed delay time is longer. In this case, when being shielded by the shield 300 during the assumed delay time in a state of an antenna and a beam during communication as they are, there is a possibility that wireless communication quality may greatly decrease. Thus, the propagation change determination unit 24 (or the selection unit 25) determines selection control of an antenna and a beam in a predicted position as “necessary (effective)”.

On the other hand, when a value of the difference is negative (less than 0), it means that the wireless quality fluctuation time is longer. In this case, even when being shielded by the shield 300 in a state of an antenna and a beam during communication as they are, updating of an antenna and a beam based on next received power information can be achieved before wireless communication quality greatly decreases. Thus, the propagation change determination unit 24 (or the selection unit 25) determines selection control of an antenna and a beam in a predicted position as “unnecessary (ineffective)”. The determination is performed by the change degree determination unit 29 in the propagation change determination unit 24, but may be performed by the selection unit 25.

In this way, the propagation change determination unit 24 determines a propagation change degree by calculating the propagation change degree, and decides, from the determined propagation change degree, whether selection control including addition and switching of an antenna and a beam is necessary. Further, the propagation change determination unit 24 may determine a propagation change degree by calculating the propagation change degree, and the selection unit 25 may decide, from the propagation change degree being determined by the propagation change determination unit 24, whether selection control including addition and switching of an antenna and a beam is necessary.

Note that, for the determination reference, whether a value is equal to or more than 1 (less than 1) or is a positive (negative) binary may not only be simply determined, and a predetermined margin and a predetermined threshold value may also be set, or a value may also be reflected as a continuous value in selection control of an antenna and a beam in terms of a probability.

### <Configuration: Selection Unit>

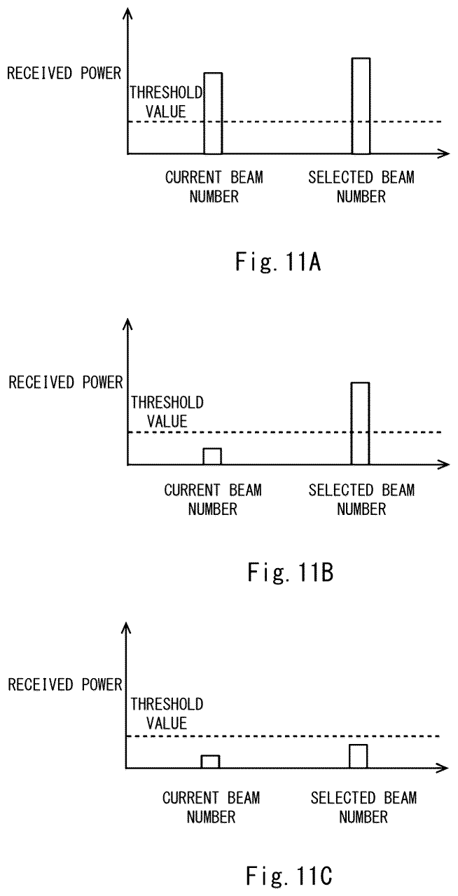

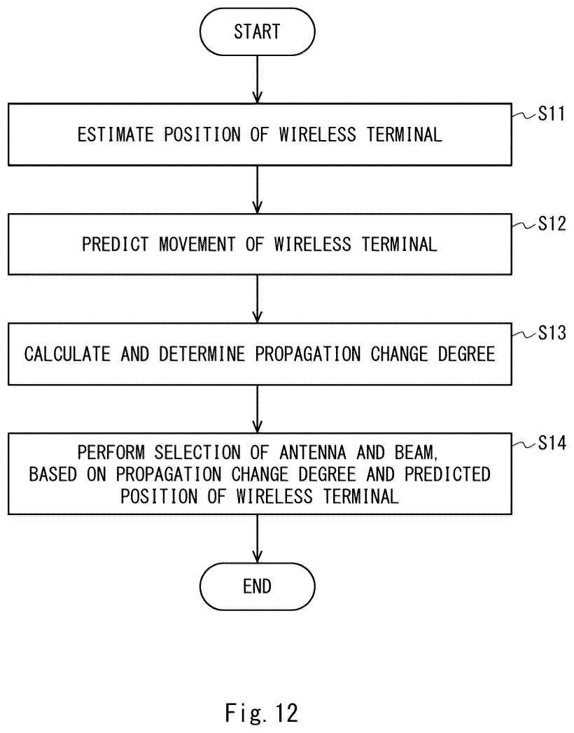

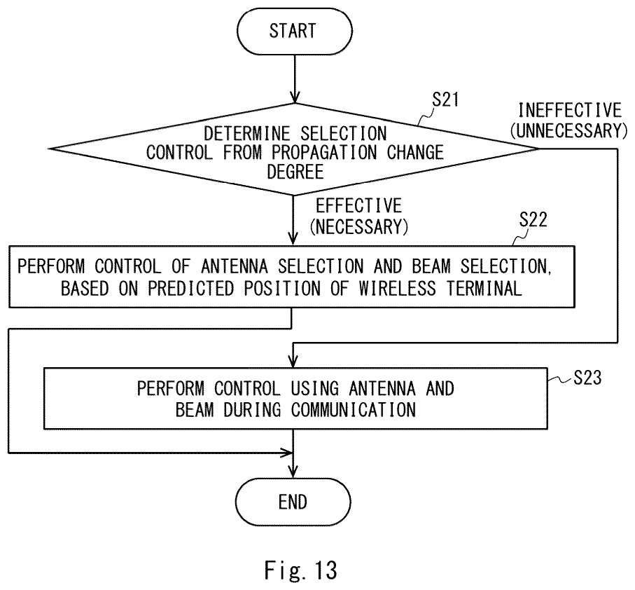

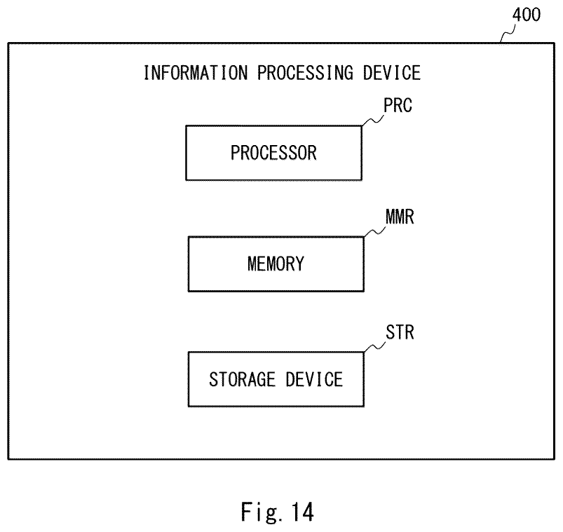

The selection unit 25 selects at least any of an antenna and a beam to be used in a predicted position being input from the movement prediction unit 22. FIGS. 11A to 11C are diagrams illustrating received power of a current beam and a selected beam according to the first example embodiment. As illustrated in FIGS. 11A to 11C, for example, the selection unit 25 selects at least any of an antenna and a beam to be used for the wireless communication by comparing the received power of the current beam with the received power of the selected beam.

A first selection method for an antenna and a beam is a method of accessing registration information about the wireless terminal 200 being recorded in the propagation information database 23, and deciding an antenna and a beam to be used. The propagation information database 23 stores position information, and information about received power for each antenna and each beam in each position and about an antenna index and a beam index having great received power in each position. The selection unit 25 accesses information about a position closest to position information being input from the movement prediction unit 22 and about received power for each antenna and each beam in a closest grid. Then, the selection unit 25 selects at least any of an antenna number and a beam number in which greatest received power is acquired.

When the selected antenna number and the selected beam number are the same as an antenna number and a beam number used for current wireless communication, no change occurs in the antenna number and the beam number used for the wireless communication of the base station antenna 110 and the like. Note that the antenna number and the beam number used for the current wireless communication may be updated by using received power information, or may be updated by using information being input from the wireless resource control unit 30.

When the selected antenna number is the same as the antenna number used for the current wireless communication, but the selected beam number is different from the beam number used for the current wireless communication, the selection unit 25 may change a beam to a beam having the selected beam number. Alternatively, when the antenna is formed of a plurality of sub-arrays, the selection unit 25 may use both beams having the selected beam number and the beam number in the current wireless communication. Alternatively, when received power of a current beam number in a predicted position is equal to or more than a predetermined threshold value (FIG. 11A), the selection unit 25 may not change the beam number. When received power of a current beam number in a predicted position is equal to or less than the predetermined threshold value (FIG. 11B or FIG. 11C), the selection unit 25 changes a beam to a beam having a selected beam number. Alternatively, the selection unit 25 may use both beams having the selected beam number and the current beam number.

When the selected antenna number is different from the antenna number used for the current wireless communication, the selection unit 25 may change an antenna to an antenna having the selected antenna number. Alternatively, the selection unit 25 may use both antennas for the wireless communication. Alternatively, when received power of a current antenna number (and a beam number in which received power is greatest) in a predicted position is equal to or more than a predetermined threshold value, the selection unit 25 may not change the antenna number. Only when the received power of the current antenna number is equal to or less than the predetermined threshold value, the selection unit 25 may change an antenna to an antenna having the selected antenna number or may use both antennas having the selected antenna number and the antenna number in the current wireless communication.

A second selection method for an antenna and a beam calculates received power for each antenna and each beam according to propagation information, based on a radio wave propagation prediction (for example, a propagation simulation by ray tracing) between the base station antenna 110 and the like and the wireless terminal 200 on a two-dimensional map or a three-dimensional map instead of received power and position information being reported from the wireless terminal 200. In this case, a size, a position, and the like of an object to be the shield 300 are also reflected in the two-dimensional map or the three-dimensional map, and a received power level for each antenna and each beam according to the propagation information at each point is estimated by performing a propagation simulation on the map. Further, in this case, a model according to a surrounding environment is needed as the propagation information, and a characteristic (for example, in a case of a train on a railroad, a penetration loss of an angle direction with respect to the wireless terminal 200 in the train, and the like) of a radio wave in the surrounding environment is generated as a model.

This simulation may be performed in real time. Further, a simulation may be performed in advance, and a result of the simulation may be recorded in the propagation information database 23 and may be referred as necessary. Further, both of a received power estimation result by the propagation simulation and a received power value being reported from the wireless terminal 200 may be used. A selected antenna number and a selected beam number are transmitted to the wireless resource control unit 30 in the centralized base station 90, and wireless resource control is performed based on the information.

Note that the selection unit 25 performs the first or second selection control described above by also using propagation change degree information from the propagation change determination unit 24. For example, when the propagation change degree information is equal to or more than 1 or is positive (>0), the propagation change determination unit 24 (or the selection unit 25) determines that selection control including addition and switching of an antenna and a beam is necessary (effective), and the selection unit 25 performs the selection control described above. On the other hand, when the propagation change degree information is less than 1 or is negative (<0), the propagation change determination unit 24 determines that selection control including addition and switching of an antenna and a beam is unnecessary (ineffective). Then, the selection unit 25 does not perform the selection control described above, and performs control using at least any of an antenna and a beam currently during communication.

When the selection control including addition and switching of an antenna and abeam is ineffective (unnecessary), an antenna number and a beam number currently during communication may be used as they are, or updating may be performed by using received power information. Further, updating may be performed by using information being input from the wireless resource control unit 30. Further, whether a value is equal to or more than 1 (less than 1) and is a positive (negative) binary may not only be simply determined, and a predetermined margin may also be set, or selection control of an antenna and a beam may be performed in terms of a probability by using a value as a continuous value. For example, control based on a predicted position and control based on information during communication may be integrated in terms of a probability, and control may be performed.

In this way, the selection unit 25 receives, from the propagation information database 23 that stores information about received power as propagation information, information about received power for each antenna and each beam in a position of the wireless terminal 200 being predicted by the movement prediction unit 22. Then, the selection unit 25 selects at least any of an antenna and a beam used for wireless communication control with the wireless terminal 200 from among a plurality of antennas and beams, based on the information about the received power for each antenna and each beam in the predicted position of the wireless terminal 200.

The selection unit 25 may select at least any of an antenna and a beam used for the wireless communication with the wireless terminal 200. Further, the selection unit 25 may select at least any of an antenna and a beam used for wireless resource control with the wireless terminal 200.

When the selection control including addition and switching of an antenna and a beam is necessary, the selection unit 25 may select at least any of an antenna and a beam, based on information about received power for each antenna and each beam in a position of the wireless terminal 200 being predicted by the movement prediction unit 22. When the selection control including addition and switching of an antenna and abeam is unnecessary, the selection unit 25 may select at least any of an antenna and a beam, based on information about received power of at least any of an antenna and a beam during communication.

Further, the selection unit 25 may select, at a predetermined probability, at least any of an antenna and a beam being selected based on information about received power for each antenna and each beam in a position of the wireless terminal 200 being predicted by the movement prediction unit 22, and at least any of an antenna and a beam being selected based on information about received power of at least any of an antenna and a beam during communication.

### <Prediction Control Method for Antenna and Beam>

Next, a prediction control method for an antenna and a beam will be described. FIG. 12 is a flowchart diagram illustrating a prediction control method in the antenna/beam prediction control unit 20 according to the first example embodiment.

As illustrated in step S11 in FIG. 12, a position of the wireless terminal 200 is estimated. For example, the position estimation unit 21 in the antenna/beam prediction control unit 20 may estimate a position of the wireless terminal 200 by using a wireless signal used in the wireless communication system 1. Further, the position estimation unit 21 may estimate a position of the wireless terminal 200 by using external information of a GPS and the like. Alternatively, position information about the wireless terminal 200 may be directly acquired from the outside.

Next, as illustrated in step S12, a movement of the wireless terminal 200 is predicted. For example, the movement prediction unit 22 may predict, from time series of the position information about the wireless terminal 200, a movement of the wireless terminal 200 by interpolation by extrapolation or by linear and curvilinear regression. Further, the movement prediction unit 22 may predict a movement of the wireless terminal 200, based on information about a past movement history of the wireless terminal 200.

Next, as illustrated in step S13, a propagation change degree is calculated and determined. For example, the propagation change determination unit 24 calculates and determines a propagation change degree indicating an extent that propagation including received power of wireless communication changes within a predetermined assumed delay time. The propagation change determination unit 24 may determine a propagation change degree from a relationship between an assumed delay time and a wireless quality fluctuation time.

Next, as illustrated in step S14, antenna selection and beam selection are performed based on the propagation change degree and the predicted position of the wireless terminal 200. FIG. 13 is a flowchart diagram illustrating a prediction control method in the propagation change determination unit 24 and the selection unit 25 according to the first example embodiment.

As illustrated in step S21 in FIG. 13, the propagation change determination unit 24 determines whether selection control of an antenna and a beam is set to be effective (necessary) or ineffective (unnecessary) from a calculated propagation change degree. When the propagation change determination unit 24 determines effective (necessary) in step S21, as illustrated in step S22, the selection unit 25 performs control of antenna selection and beam selection, based on not only information about an antenna and a beam currently during communication but also a predicted position of the wireless terminal 200.

On the other hand, when the propagation change determination unit 24 determines ineffective (unnecessary) in step S21, as illustrated in step S23, the selection unit 25 performs control using an antenna and a beam during communication. In this way, prediction control of an antenna and a beam is performed. Note that the determination is performed by the propagation change determination unit 24, but may be performed by the selection unit 25.

### <Effect>

Next, an effect of the present example embodiment will be described. In the present example embodiment described above, the antenna/beam prediction control unit 20 calculates a propagation change degree by using movement speed information. The antenna/beam prediction control unit 20 determines, by using the calculated propagation change degree information, whether selection control of an antenna and a beam in a predicted position is necessary. Then, after that, the antenna/beam prediction control unit 20 performs selection of an antenna and a beam to be used for communication. In this way, stable communication quality can be achieved with a minimum necessary amount of a wireless resource.

The reason is described as follows. When selection of a plurality of beams and antennas is performed based on both of a current state and a predicted position, there is a possibility that system throughput may be limited by redundant usage of a wireless resource. For such a problem, in the present example embodiment, for example, a propagation change degree is calculated for each wireless terminal 200 from a relationship between an assumed delay time and a wireless quality fluctuation time. When selection control of an antenna and a beam is determined to be unnecessary from the propagation change degree information being determined by the propagation change determination unit 24, the selection unit 25 does not perform the selection control of an antenna and a beam in a predicted position of the wireless terminal 200. Thus, redundant usage of a wireless resource can be suppressed for stable communication quality.

For example, even when quality of an antenna and a beam being selected based on a predicted position is better, in a case of a small propagation change degree, communication quality does not greatly decrease with a current antenna and a current beam to an extent that a connection is interrupted. Thus, addition of an antenna and a beam is not performed based on a predicted position, and control can be performed in such a way as to select a new antenna and a new beam at a next control timing. In this way, an antenna and a beam that are not added can be assigned to the other wireless terminal 200, for example, and thus a wireless resource can be effectively used.

Note that the present example embodiment also includes a characteristic in which whether selection control of an antenna and a beam is necessary is determined by calculating a propagation change degree only from movement speed information about each wireless terminal 200. Particularly, the present example embodiment also includes a characteristic for calculating an assumed delay time and a radio wave line-of-sight space for each wireless terminal 200, and calculating a propagation change degree. Thus, even in a case of the wireless terminal 200 at the same movement speed, a determination result is different depending on a delay and an environment for each wireless terminal 200 at that point of time. Thus, there is also an advantage of being able to achieve more optimum wireless resource control (antenna selection and beam selection).

### Second Example Embodiment

Next, a second example embodiment will be described. The present example embodiment includes an addition element to at least any of the configurations in the example embodiment described above.

For example, the present example embodiment can further perform the following methods as propagation change determination and a usage method for propagation change degree information.

A propagation change determination unit 24 may consider a movement speed of not only a wireless terminal 200 but also a shield 300 including an obstacle and the like. When the shield 300 that is moving is assumed, and a movement speed and a direction of the shield 300 can be estimated, the propagation change determination unit 24 may calculate a propagation change degree with, as a movement speed of the shield 300, a relative speed to a speed of the wireless terminal 200. For example, when there is a possibility that the wireless terminal 200 at a speed A and the shield 300 at a speed B face each other and move on the same straight line, the propagation change determination unit 24 may perform calculation with A+B as a movement speed. Further, when a movement speed and a direction of the shield 300 are not known, the propagation change determination unit 24 may assume a movement speed and a direction of the shield 300 fixedly according to an environment. Further, the propagation change determination unit 24 may assume, as a speed of the shield 300, a movement speed of the wireless terminal 200 that is moving the fastest among the other wireless terminals 200 close to the wireless terminal 200 being a target.

The propagation change determination unit 24 may output information about a propagation change degree. Then, a movement prediction unit 22 (or a selection unit 25) described above may update a prediction of a movement including a predicted time and a predicted position of the wireless terminal 200 by using the information about the propagation change degree. For example, when the propagation change determination unit 24 outputs a calculated ratio (proportion) as the information about the propagation change degree, the movement prediction unit 22 may multiply the information about the propagation change degree by a predicted time. On the other hand, for example, when the propagation change determination unit 24 outputs a calculated difference (comparison of magnitude) as the information about the propagation change degree, the movement prediction unit 22 may add or subtract a predicted time to or from the information about the propagation change degree. Note that the example of updating a predicted time in the movement prediction unit 22 is exemplified above, but, as another method, updating to a predicted position associated with a predicted time needed to be updated may be performed from a relationship between a current position and an original predicted position in the selection unit 25 by using information about a propagation change degree.

Further, for example, the following methods may be further performed as a method of selecting an antenna and a beam.

The selection unit 25 may input slice information for each wireless terminal 200 and each wireless communication from a higher control device or a wireless base station device 100, and may decide whether selection control including addition and switching of an antenna and a beam is necessary, based on the slice information. For example, when the slice information is a slice that particularly needs reliability, the selection unit 25 may perform control in such a way as to always set selection control of an antenna and a beam based on a predicted position to be effective (necessary), and the like. On the other hand, for example, in a case of a slice having no problem at all even with low reliability, the selection unit 25 may always set selection control of an antenna and a beam using a predicted position to be ineffective (unnecessary), and may perform the selection control of an antenna and a beam, based on current received power information.

When the selection control of an antenna and a beam is used based on information being registered in a propagation information database 23, a surrounding environment may be different from that when being recorded and learned in the propagation information database 23 (a case where the shield 300 such as a large truck is parked). In such a case, there is a possibility that an appropriate antenna and an appropriate beam cannot be selected.

Thus, in a current position and a plurality of positions up to the current position, received power for each antenna and each beam being actually used for communication is compared with received power being registered in the propagation information database 23. Then, prediction accuracy of the propagation information database 23 can be evaluated from a comparison result. When the prediction accuracy is determined to be high as a result of the comparison, an antenna number and a beam number selected by the result being registered in the propagation information database 23 are used. On the contrary, when the prediction accuracy is determined to be low, an antenna number and a beam number being used for current communication are not changed. Further, in a case between the both cases, both antenna numbers and both beam numbers may be used.

In this way, the selection unit 25 may evaluate prediction accuracy by comparing a measurement value of received power for each antenna and each beam being actually used for wireless communication in a current position of the wireless terminal 200 and a position in a movement history, with received power for each antenna and each beam being predicted in each position, and may then select at least any of an antenna and a beam.

In the description above, an antenna number and a beam number being selected by the selection unit 25 are assumed to be one set, but a plurality of sets of antenna numbers and beam numbers can also be selected. For example, there is a case where all levels of estimation values of received power in an antenna number and a beam number being used for current communication and an antenna number and a beam number being selected by the selection unit 25 are low. In that case, an antenna number and a beam number estimated to have next greatest received power can also be set in addition. In this way, although redundancy increases, there is a possibility that connectivity can be improved.

Further, as a different method of selecting a plurality of sets of antenna numbers and beam numbers, for example, the selection unit 25 may add and set (select) a plurality of sets of antenna numbers and beam numbers, based on not only a position being predicted by a movement prediction but also a plurality of positions from a current position to a position being predicted by a movement prediction. Similarly, also in this case, although redundancy increases, there is a possibility that connectivity can be improved.

In this way, the selection unit 25 may decide a usage candidate of an antenna and a beam for a plurality of positions being predicted by the movement prediction unit 22, and select at least any of an antenna and a beam to be actually used from all candidates. Further, the selection unit 25 may select at least any of an antenna and a beam, based on a relationship among received power predicted in an antenna and a beam to be a candidate of selection, a measurement value of received power in an antenna and a beam during communication, and a predetermined threshold value of the received power.

Meanwhile, using many antennas and beams also leads to a limitation on system throughput. Thus, in consideration of a current wireless resource usage rate in a base station antenna 110 and the like, control according to the wireless resource usage rate may be used in such a way that usage of a redundant antenna and a redundant beam is permitted only when the wireless resource usage rate is low, and the like. Specifically, the selection unit 25 may decide the number of antennas to be used simultaneously and the number of beams to be used simultaneously according to the wireless resource usage rate.

Further, as described above, as a different method of efficiently using a wireless resource, the selection unit 25 may select at least any of an antenna and a beam, based on a relationship among a measurement value of received power in an antenna and a beam during communication, predicted received power in each antenna and beam to be a candidate of selection in a predicted position, and a predetermined threshold value of the received power. For example, the selection unit 25 may add or select an antenna and a beam in a predicted position only when a predicted value of received power in an antenna and a beam currently during communication in the predicted position decreases beyond a predetermined threshold value.

The selection unit 25 may select an antenna and a beam, based on not only a position of the wireless terminal 200 being predicted at a predetermined time ahead but also a plurality of positions of the wireless terminal 200 being predicted at a time farther ahead. For example, when an antenna number estimated to have greatest received power is switched many times in a plurality of predicted positions of the wireless terminal 200, the selection unit 25 can also select an antenna number in which occurrence of a frequent change in antenna number is avoided.

For at least any of position estimation and a movement prediction, position information (a position of the wireless terminal 200 in any time period) and movement prediction information (position information and a movement speed of the wireless terminal 200 being predicted after an assumed delay time) about the wireless terminal 200, and the like may be directly acquired from the outside without estimation and a prediction inside the wireless base station device 100.

Further, a movement speed of the wireless terminal 200 may be calculated from a Doppler frequency estimated from wireless quality information such as received power information.

Selection of an antenna and a beam can also be performed in consideration of accuracy of position information (at least any of position estimation and a movement prediction). For example, the selection unit 25 may select at least any of an antenna and a beam with a plurality of predicted positions as candidates according to accuracy of position information.

When accuracy of predicted position information about the wireless terminal 200 is determined to be low, the propagation information database 23 is referred in several positions of the wireless terminal 200 in a direction of the position information. Then, a plurality of antenna numbers and beam numbers predicted to have greatest received power in each of the positions can also be set. For example, when position information is managed by a grid, an antenna number and a beam number predicted to have greatest received power may be set by including a surrounding grid of a grid including a predicted position being predicted by the movement prediction unit 22.

Each unit of the wireless base station device 100, the antenna/beam prediction control unit 20, the position estimation unit 21, the movement prediction unit 22, the propagation change determination unit 24, and the selection unit 25 illustrated in FIGS. 5 to 7 is described as a part of the wireless base station device 100, which is not limited thereto. For example, a part or the whole of each unit in FIGS. 5 to 7 may be mounted on any of a radio unit (RU), a distributed unit (DU), and a central unit (CU) of a wireless base station. Further, a part or the whole of each unit in FIGS. 5 to 7 may be mounted on an external device such as a RAN intelligent controller (RIC) other than the wireless base station device 100.

In this way, the wireless control device includes a first control device and a second control device, and at least any of the position estimation unit 21, the movement prediction unit 22, the propagation information database 23, the propagation change determination unit 24, and the selection unit 25 may be provided in the first control device, and a unit other than a unit provided in the first control device among the position estimation unit 21, the movement prediction unit 22, the propagation information database 23, the propagation change determination unit 24, and the selection unit 25 may be provided in the second control device. The first control device and the second control device in this case may be any of the wireless base station device 100, the RU, the DU, the CU, and the RIC.

Further, an application destination is not only wireless communication of a millimeter wave and the like, and may be applied to communication of a terahertz wave (sub-terahertz wave), optical space communication (free space optical communication), visible light communication (optical wireless communication), and the like.

Note that the present disclosure is not limited to the example embodiments described above, and may be appropriately modified without departing from the scope of the present disclosure. For example, an example embodiment acquired by combining the configurations of the first and second example embodiments is included within the scope of a technical idea. Further, a wireless control program that causes a computer to perform a wireless control method is also included within the scope of a technical idea.

The wireless control device 20a described above may be an information processing device such as a microcomputer, a personal computer, and a server, for example. FIG. 14 is a block diagram illustrating a case where the wireless control device 20a according to the first and second example embodiments is achieved by an information processing device. As illustrated in FIG. 14, an information processing device 400 may include a processor PRC, a memory MMR, and a storage device STR. The storage device STR may store, as a program, processing performed by each configuration of the wireless control device 20a. Further, the processor PRC may read the program from the storage device STR into the memory MMR, and execute the program. In this way, the processor PRC achieves a function of each configuration in the wireless control device 20a. The information processing device 400 may achieve the wireless control device 20a illustrated in FIG. 2 by causing the processor PRC to execute a program associated with the movement prediction unit 22a, the propagation change determination unit 24a, and the selection unit 25a while referring to the memory MMR and the storage device STR.

Each configuration included in the wireless control device 20a may each be achieved by dedicated hardware. Further, a part or the whole of each of the components may be achieved by general-purpose or dedicated circuitry, the processor PRC, and the like, or achieved by a combination thereof. A part or the whole of each of the components may be formed by a single chip or formed by a plurality of chips connected to one another via a bus. A part or the whole of each of the components may be achieved by a combination of the above-described circuitry and the like and a program. Further, as the processor PRC, a central processing unit (CPU), a graphics processing unit (GPU), a field-programmable gate array (FPGA), a quantum processor (quantum computer control chip), or the like can be used.

When a part or the whole of each of the components of the wireless control device 20a is achieved by a plurality of information processing devices, circuitry, or the like, the plurality of information processing devices, the circuitry, or the like may be arranged in a centralized manner or a distributed manner. For example, the information processing devices, the circuitry, and the like may be achieved as a form in which those are connected with each other via a client server system, a cloud computing system, or the like. Further, the function of the wireless control device 20a may be provided in a SaaS (Software as a Service) form.

When the program is read by the wireless control device 20a and the like including a computer, the program includes a command group (or software codes) for causing the computer to perform one or more of the functions described in the example embodiments. The program may be stored in a non-transitory computer-readable medium or a tangible storage medium. Examples of the computer-readable medium or the tangible storage medium include a random-access memory (RAM), a read-only memory (ROM), a flash memory, a solid-state drive (SSD), or other memory technique, a CD-ROM, a digital versatile disc (DVD), a Blu-ray (registered trademark) disc, or other optical disc storage, a magnetic cassette, a magnetic tape, a magnetic disc storage, or other magnetic storage device, which are not limited thereto. The program may be transmitted on a transitory computer-readable medium or a communication medium. Examples of the transitory computer-readable medium or the communication medium include electrical, optical, acoustic, or other form of propagation signals, which are not limited thereto.

A part or the whole of the above-described example embodiments may also be described as in supplementary notes below, which is not limited thereto.

### (Supplementary Note 1)

A wireless control device including:
a movement prediction unit configured to predict a movement of a wireless terminal configured to perform wireless communication;
a propagation change determination unit configured to determine a propagation change degree indicating a degree of an extent that propagation of the wireless communication including received power of the wireless communication changes within a predetermined assumed delay time; and
a selection unit configured to select, from among a plurality of antennas and a plurality of beams, at least any of the antenna and the beam used for wireless communication control with the wireless terminal, based on the propagation change degree being determined by the propagation change determination unit.

### (Supplementary Note 2)

The wireless control device according to Supplementary Note 1, wherein the selection unit receives, from a propagation information storage unit configured to store information about the received power as propagation information, information about the received power for each of the antennas and each of the beams in a position of the wireless terminal being predicted by the movement prediction unit, and selects at least any of the antenna and the beam used for the wireless communication control with the wireless terminal, based on information about the received power for each of the antennas and each of the beams in a predicted position of the wireless terminal.

### (Supplementary Note 3)

The wireless control device according to Supplementary Note 2, wherein the propagation change determination unit determines the propagation change degree by calculating the propagation change degree, and decides, from the determined propagation change degree, whether selection control including addition and switching of the antenna and the beam is necessary.

### (Supplementary Note 4)

The wireless control device according to Supplementary Note 2, wherein the propagation change determination unit determines the propagation change degree by calculating the propagation change degree, and the selection unit decides, from the propagation change degree being determined by the propagation change determination unit, whether selection control including addition and switching of the antenna and the beam is necessary.

### (Supplementary Note 5)

The wireless control device according to any one of Supplementary Notes 1 to 4, wherein the selection unit selects at least any of the antenna and the beam used for the wireless communication with the wireless terminal.

### (Supplementary Note 6)

The wireless control device according to any one of Supplementary Notes 1 to 4, wherein the selection unit selects at least any of the antenna and the beam used for wireless resource control with the wireless terminal.

### (Supplementary Note 7)

The wireless control device according to any one of Supplementary Notes 1 to 6, wherein the propagation change determination unit determines the propagation change degree from a relationship between the assumed delay time and a quality fluctuation time of the wireless communication.

### (Supplementary Note 8)

The wireless control device according to Supplementary Note 7, wherein the assumed delay time includes a time from a first timing at which information about the received power is received to a second timing at which the assumed delay time is updated in accordance with information about the received power being received next.

### (Supplementary Note 9)

The wireless control device according to Supplementary Note 7 or 8, wherein a quality fluctuation time of the wireless communication includes a time in which the received power decreases to equal to or less than a predetermined threshold value when a radio wave used for the wireless communication is blocked by a shield.

### (Supplementary Note 10)

The wireless control device according to any one of Supplementary Notes 7 to 9, wherein a quality fluctuation time of the wireless communication is calculated by dividing a width of a line-of-sight space of the radio wave by a movement speed of the wireless terminal.

### (Supplementary Note 11)

The wireless control device according to Supplementary Note 10, wherein a width of a line-of-sight space of the radio wave includes a Fresnel radius or diameter in a Fresnel zone from the wireless terminal.

### (Supplementary Note 12)

The wireless control device according to any one of Supplementary Notes 1 to 11, wherein the propagation change determination unit determines the propagation change degree from a relationship among the assumed delay time for each of the wireless terminals, information indicating a line-of-sight space of a radio wave used for the wireless communication, and predicted movement information about the wireless terminal.

### (Supplementary Note 13)

The wireless control device according to any one of Supplementary Notes 1 to 12, wherein
the propagation change determination unit outputs the propagation change degree, and
the movement prediction unit updates a prediction of a movement of the wireless terminal, based on the output propagation change degree.

### (Supplementary Note 14)

The wireless control device according to Supplementary Note 3 or 4, wherein the selection unit selects, when the selection control is necessary, at least any of the antenna and the beam, based on information about the received power for each of the antennas and each of the beams in a position of the wireless terminal being predicted by the movement prediction unit, and selects, when the selection control is unnecessary, at least any of the antenna and the beam, based on information about the received power of at least any of the antenna and the beam during communication.

### (Supplementary Note 15)

The wireless control device according to any one of Supplementary Notes 1 to 14, wherein the selection unit selects, at a predetermined probability, at least any of the antenna and the beam being selected based on information about the received power for each of the antennas and each of the beams in a position of the wireless terminal being predicted by the movement prediction unit, and at least any of the antenna and the beam being selected based on information about the received power of at least any of the antenna and the beam during communication.

### (Supplementary Note 16)

The wireless control device according to any one of Supplementary Notes 1 to 15, wherein the movement prediction unit predicts a position and a speed of the wireless terminal, based on information about at least any of time series of position information about the wireless terminal, a movement history of the wireless terminal, and a map around the wireless terminal.

### (Supplementary Note 17)

The wireless control device according to any one of Supplementary Notes 1 to 16, further including a position estimation unit configured to estimate a position of the wireless terminal.

### (Supplementary Note 18)

The wireless control device according to Supplementary Note 17, wherein the position estimation unit estimates a position of the wireless terminal, based on at least any of the propagation information, information about the received power, and arrival time information about a radio wave.

### (Supplementary Note 19)

The wireless control device according to any one of Supplementary Notes 1 to 18, wherein the selection unit selects at least any of the antenna and the beam, based on a relationship among the received power predicted in the antenna and the beam to be a candidate of selection, a measurement value of the received power in the antenna and the beam during communication, and a predetermined threshold value of the received power.

### (Supplementary Note 20)

The wireless control device according to any one of Supplementary Notes 1 to 19, wherein the selection unit selects at least any of the antenna and the beam, based on a plurality of positions from a current position of the wireless terminal to a position being predicted by the movement prediction unit.

### (Supplementary Note 21)

The wireless control device according to any one of Supplementary Notes 1 to 20, wherein the selection unit evaluates prediction accuracy by comparing a measurement value of the received power for each of the antennas and each of the beams being actually used for the wireless communication in a current position of the wireless terminal and a position in a movement history, with the received power for each of the antennas and each of the beams being predicted in each position, and then selects at least any of the antenna and the beam.

### (Supplementary Note 22)

The wireless control device according to any one of Supplementary Notes 1 to 21, wherein the selection unit selects at least any of the antenna and the beam with a plurality of predicted positions as candidates according to accuracy of position information.

### (Supplementary Note 23)

The wireless control device according to any one of Supplementary Notes 1 to 22, wherein the selection unit decides the number of the antennas to be used simultaneously and the number of the beams to be used simultaneously according to a wireless resource usage rate.

### (Supplementary Note 24)

The wireless control device according to any one of Supplementary Notes 1 to 23, wherein the selection unit decides a usage candidate of the antenna and the beam for a plurality of positions being predicted by the movement prediction unit, and selects at least any of the antenna and the beam to be actually used from all candidates.

### (Supplementary Note 25)

The wireless control device according to any one of Supplementary Notes 1 to 24, wherein the selection unit inputs slice information for each of the wireless terminals and each piece of the wireless communication from a higher control device or a wireless base station device, and decides whether selection control including addition and switching of the antenna and the beam is necessary, based on the slice information.

### (Supplementary Note 26)

The wireless control device according to any one of Supplementary Notes 1 to 25, further including
a first control device and a second control device, wherein
at least any of the movement prediction unit, the propagation change determination unit, and the selection unit is provided in the first control device, and
a unit other than a unit provided in the first control device among the movement prediction unit, the propagation change determination unit, and the selection unit is provided in the second control device.

### (Supplementary Note 1A)

A wireless base station device including:
a movement prediction unit configured to predict a movement of a wireless terminal configured to perform wireless communication;
a propagation change determination unit configured to determine a propagation change degree indicating a degree of an extent that propagation of the wireless communication including received power of the wireless communication changes within a predetermined assumed delay time; and
a selection unit configured to select, from among a plurality of antennas and a plurality of beams, at least any of the antenna and the beam used for wireless communication control with the wireless terminal, based on the propagation change degree being determined by the propagation change determination unit.

### (Supplementary Note 2A)

The wireless base station device according to Supplementary Note 1A, wherein the selection unit receives, from a propagation information storage unit configured to store information about the received power as propagation information, information about the received power for each of the antennas and each of the beams in a position of the wireless terminal being predicted by the movement prediction unit, and selects at least any of the antenna and the beam used for the wireless communication control with the wireless terminal, based on information about the received power for each of the antennas and each of the beams in a predicted position of the wireless terminal.

### (Supplementary Note 3A)

The wireless base station device according to Supplementary Note 2A, wherein the propagation change determination unit determines the propagation change degree by calculating the propagation change degree, and decides, from the determined propagation change degree, whether selection control including addition and switching of the antenna and the beam is necessary.

### (Supplementary Note 4A)

The wireless base station device according to Supplementary Note 2A, wherein
the propagation change determination unit determines the propagation change degree by calculating the propagation change degree, and
the selection unit decides, from the propagation change degree being determined by the propagation change determination unit, whether selection control including addition and switching of the antenna and the beam is necessary.

### (Supplementary Note 5A)

The wireless base station device according to any one of Supplementary Notes 1A to 4A, wherein the selection unit selects at least any of the antenna and the beam used for the wireless communication with the wireless terminal.

### (Supplementary Note 6A)

The wireless base station device according to any one of Supplementary Notes 1A to 4A, wherein the selection unit selects at least any of the antenna and the beam used for wireless resource control with the wireless terminal.

### (Supplementary Note 7A)

The wireless base station device according to any one of Supplementary Notes 1A to 6A, wherein the propagation change determination unit determines the propagation change degree from a relationship between the assumed delay time and a quality fluctuation time of the wireless communication.

### (Supplementary Note 8A)

The wireless base station device according to Supplementary Note 7A, wherein the assumed delay time includes a time from a first timing at which information about the received power is received to a second timing at which the assumed delay time is updated in accordance with information about the received power being received next.

### (Supplementary Note 9A)

The wireless base station device according to Supplementary Note 7A or 8A, wherein a quality fluctuation time of the wireless communication includes a time in which the received power decreases to equal to or less than a predetermined threshold value when a radio wave used for the wireless communication is blocked by a shield.

### (Supplementary Note 10A)

The wireless base station device according to any one of Supplementary Notes 7A to 9A, wherein a quality fluctuation time of the wireless communication is calculated by dividing a width of a line-of-sight space of the radio wave by a movement speed of the wireless terminal.

### (Supplementary Note 11A)

The wireless base station device according to Supplementary Note 10A, wherein a width of a line-of-sight space of the radio wave includes a Fresnel radius or diameter in a Fresnel zone from the wireless terminal.

### (Supplementary Note 12A)

The wireless base station device according to any one of Supplementary Notes 1A to 11A, wherein the propagation change determination unit determines the propagation change degree from a relationship among the assumed delay time for each of the wireless terminals, information indicating a line-of-sight space of a radio wave used for the wireless communication, and predicted movement information about the wireless terminal.

### (Supplementary Note 13A)

The wireless base station device according to any one of Supplementary Notes 1A to 12A, wherein
the propagation change determination unit outputs the propagation change degree, and
the movement prediction unit updates a prediction of a movement of the wireless terminal, based on the output propagation change degree.

### (Supplementary Note 14A)

The wireless base station device according to Supplementary Note 3A or 4A, wherein the selection unit selects, when the selection control is necessary, at least any of the antenna and the beam, based on information about the received power for each of the antennas and each of the beams in a position of the wireless terminal being predicted by the movement prediction unit, and selects, when the selection control is unnecessary, at least any of the antenna and the beam, based on information about the received power of at least any of the antenna and the beam during communication.

### (Supplementary Note 15A)

The wireless base station device according to any one of Supplementary Notes 1A to 14A, wherein the selection unit selects, at a predetermined probability, at least any of the antenna and the beam being selected based on information about the received power for each of the antennas and each of the beams in a position of the wireless terminal being predicted by the movement prediction unit, and at least any of the antenna and the beam being selected based on information about the received power of at least any of the antenna and the beam during communication.

### (Supplementary Note 16A)

The wireless base station device according to any one of Supplementary Notes 1A to 15A, wherein the movement prediction unit predicts a position and a speed of the wireless terminal, based on information about at least any of time series of position information about the wireless terminal, a movement history of the wireless terminal, and a map around the wireless terminal.

### (Supplementary Note 17A)

The wireless base station device according to any one of Supplementary Notes 1A to 16A, further including a position estimation unit configured to estimate a position of the wireless terminal.

### (Supplementary Note 18A)

The wireless base station device according to Supplementary Note 17A, wherein the position estimation unit estimates a position of the wireless terminal, based on at least any of the propagation information, information about the received power, and arrival time information about a radio wave.

### (Supplementary Note 19A)

The wireless base station device according to any one of Supplementary Notes 1A to 18A, wherein the selection unit selects at least any of the antenna and the beam, based on a relationship among the received power predicted in the antenna and the beam to be a candidate of selection, a measurement value of the received power in the antenna and the beam during communication, and a predetermined threshold value of the received power.

### (Supplementary Note 20A)

The wireless base station device according to any one of Supplementary Notes 1A to 19A, wherein the selection unit selects at least any of the antenna and the beam, based on a plurality of positions from a current position of the wireless terminal to a position being predicted by the movement prediction unit.

### (Supplementary Note 21A)

The wireless base station device according to any one of Supplementary Notes 1A to 20A, wherein the selection unit evaluates prediction accuracy by comparing a measurement value of the received power for each of the antennas and each of the beams being actually used for the wireless communication in a current position of the wireless terminal and a position in a movement history, with the received power for each of the antennas and each of the beams being predicted in each position, and then selects at least any of the antenna and the beam.

### (Supplementary Note 22A)

The wireless base station device according to any one of Supplementary Notes 1A to 21A, wherein the selection unit selects at least any of the antenna and the beam with a plurality of predicted positions as candidates according to accuracy of position information.

### (Supplementary Note 23A)

The wireless base station device according to any one of Supplementary Notes TA to 22A, wherein the selection unit decides the number of the antennas to be used simultaneously and the number of the beams to be used simultaneously according to a wireless resource usage rate.

### (Supplementary Note 24A)

The wireless base station device according to any one of Supplementary Notes TA to 23A, wherein the selection unit decides a usage candidate of the antenna and the beam for a plurality of positions being predicted by the movement prediction unit, and selects at least any of the antenna and the beam to be actually used from all candidates.

### (Supplementary Note 25A)

The wireless base station device according to any one of Supplementary Notes TA to 24A, wherein the selection unit inputs slice information for each of the wireless terminals and each piece of the wireless communication from a higher control device or a wireless base station device, and decides whether selection control including addition and switching of the antenna and the beam is necessary, based on the slice information.

### (Supplementary Note 26A)

The wireless base station device according to any one of Supplementary Notes TA to 25A, further including
a first control device and a second control device, wherein
at least any of the movement prediction unit, the propagation change determination unit, and the selection unit is provided in the first control device, and
a unit other than a unit provided in the first control device among the movement prediction unit, the propagation change determination unit, and the selection unit is provided in the second control device.
   (Supplementary Note 1B) A wireless communication system including:
at least one wireless terminal; and
a wireless control device configured to perform wireless communication with the wireless terminal, wherein
the wireless control device includes
a movement prediction unit configured to predict a movement of the wireless terminal;
a propagation change determination unit configured to determine a propagation change degree indicating a degree of an extent that propagation of the wireless communication including received power of the wireless communication changes within a predetermined assumed delay time; and
a selection unit configured to select, from among a plurality of antennas and a plurality of beams, at least any of the antenna and the beam used for wireless communication control with the wireless terminal, based on the propagation change degree being determined by the propagation change determination unit.

### (Supplementary Note 2B)

The wireless communication system according to Supplementary Note 1B, wherein the selection unit receives, from a propagation information storage unit configured to store information about the received power as propagation information, information about the received power for each of the antennas and each of the beams in a position of the wireless terminal being predicted by the movement prediction unit, and selects at least any of the antenna and the beam used for the wireless communication control with the wireless terminal, based on information about the received power for each of the antennas and each of the beams in a predicted position of the wireless terminal.

### (Supplementary Note 3B)

The wireless communication system according to Supplementary Note 2B, wherein the propagation change determination unit determines the propagation change degree by calculating the propagation change degree, and decides, from the determined propagation change degree, whether selection control including addition and switching of the antenna and the beam is necessary.

### (Supplementary Note 4B)

The wireless communication system according to Supplementary Note 2B, wherein
the propagation change determination unit determines the propagation change degree by calculating the propagation change degree, and
the selection unit decides, from the propagation change degree being determined by the propagation change determination unit, whether selection control including addition and switching of the antenna and the beam is necessary.

### (Supplementary Note 5B)

The wireless communication system according to any one of Supplementary Notes 1B to 4B, wherein the selection unit selects at least any of the antenna and the beam used for the wireless communication with the wireless terminal.

### (Supplementary Note 6B)

The wireless communication system according to any one of Supplementary Notes 1B to 4B, wherein the selection unit selects at least any of the antenna and the beam used for wireless resource control with the wireless terminal.

### (Supplementary Note 7B)

The wireless communication system according to any one of Supplementary Notes 1B to 6B, wherein the propagation change determination unit determines the propagation change degree from a relationship between the assumed delay time and a quality fluctuation time of the wireless communication.

### (Supplementary Note 8B)

The wireless communication system according to Supplementary Note 7B, wherein the assumed delay time includes a time from a first timing at which information about the received power is received to a second timing at which the assumed delay time is updated in accordance with information about the received power being received next.

### (Supplementary Note 9B)

The wireless communication system according to Supplementary Note 7B or 8B, wherein a quality fluctuation time of the wireless communication includes a time in which the received power decreases to equal to or less than a predetermined threshold value when a radio wave used for the wireless communication is blocked by a shield.

### (Supplementary Note 10B)

The wireless communication system according to any one of Supplementary Notes 7B to 9B, wherein a quality fluctuation time of the wireless communication is calculated by dividing a width of a line-of-sight space of the radio wave by a movement speed of the wireless terminal.

### (Supplementary Note 11B)

The wireless communication system according to Supplementary Note 10B, wherein a width of a line-of-sight space of the radio wave includes a Fresnel radius or diameter in a Fresnel zone from the wireless terminal.

### (Supplementary Note 12B)

The wireless communication system according to any one of Supplementary Notes 1B to 11B, wherein the propagation change determination unit determines the propagation change degree from a relationship among the assumed delay time for each of the wireless terminals, information indicating a line-of-sight space of a radio wave used for the wireless communication, and predicted movement information about the wireless terminal.

### (Supplementary Note 13B)

The wireless communication system according to any one of Supplementary Notes 1B to 12B, wherein
the propagation change determination unit outputs the propagation change degree, and
the movement prediction unit updates a prediction of a movement of the wireless terminal, based on the output propagation change degree.

### (Supplementary Note 14B)

The wireless communication system according to Supplementary Note 3B or 4B, wherein the selection unit selects, when the selection control is necessary, at least any of the antenna and the beam, based on information about the received power for each of the antennas and each of the beams in a position of the wireless terminal being predicted by the movement prediction unit, and selects, when the selection control is unnecessary, at least any of the antenna and the beam, based on information about the received power of at least any of the antenna and the beam during communication.

### (Supplementary Note 15B)

The wireless communication system according to any one of Supplementary Notes 1B to 14B, wherein the selection unit selects, at a predetermined probability, at least any of the antenna and the beam being selected based on information about the received power for each of the antennas and each of the beams in a position of the wireless terminal being predicted by the movement prediction unit, and at least any of the antenna and the beam being selected based on information about the received power of at least any of the antenna and the beam during communication.

### (Supplementary Note 16B)

The wireless communication system according to any one of Supplementary Notes 1B to 15B, wherein the movement prediction unit predicts a position and a speed of the wireless terminal, based on information about at least any of time series of position information about the wireless terminal, a movement history of the wireless terminal, and a map around the wireless terminal.

### (Supplementary Note 17B)

The wireless communication system according to any one of Supplementary Notes 1B to 16B, further including a position estimation unit configured to estimate a position of the wireless terminal.

### (Supplementary Note 18B)

The wireless communication system according to Supplementary Note 17B, wherein the position estimation unit estimates a position of the wireless terminal, based on at least any of the propagation information, information about the received power, and arrival time information about a radio wave.

### (Supplementary Note 19B)

The wireless communication system according to any one of Supplementary Notes 1B to 18B, wherein the selection unit selects at least any of the antenna and the beam, based on a relationship among the received power predicted in the antenna and the beam to be a candidate of selection, a measurement value of the received power in the antenna and the beam during communication, and a predetermined threshold value of the received power.

### (Supplementary Note 20B)

The wireless communication system according to any one of Supplementary Notes 1B to 19B, wherein the selection unit selects at least any of the antenna and the beam, based on a plurality of positions from a current position of the wireless terminal to a position being predicted by the movement prediction unit.

### (Supplementary Note 21B)

The wireless communication system according to any one of Supplementary Notes 1B to 20B, wherein the selection unit evaluates prediction accuracy by comparing a measurement value of the received power for each of the antennas and each of the beams being actually used for the wireless communication in a current position of the wireless terminal and a position in a movement history, with the received power for each of the antennas and each of the beams being predicted in each position, and then selects at least any of the antenna and the beam.

### (Supplementary Note 22B)

The wireless communication system according to any one of Supplementary Notes 1B to 21B, wherein the selection unit selects at least any of the antenna and the beam with a plurality of predicted positions as candidates according to accuracy of position information.

### (Supplementary Note 23B)

The wireless communication system according to any one of Supplementary Notes 1B to 22B, wherein the selection unit decides the number of the antennas to be used simultaneously and the number of the beams to be used simultaneously according to a wireless resource usage rate.

### (Supplementary Note 24B)

The wireless communication system according to any one of Supplementary Notes 1B to 23B, wherein the selection unit decides a usage candidate of the antenna and the beam for a plurality of positions being predicted by the movement prediction unit, and selects at least any of the antenna and the beam to be actually used from all candidates.

### (Supplementary Note 25B)

The wireless communication system according to any one of Supplementary Notes 1B to 24B, wherein the selection unit inputs slice information for each of the wireless terminals and each piece of the wireless communication from a higher control device or a wireless base station device, and decides whether selection control including addition and switching of the antenna and the beam is necessary, based on the slice information.

### (Supplementary Note 26B)

The wireless communication system according to any one of Supplementary Notes 1B to 25B, wherein
the wireless control device includes a first control device and a second control device,
at least any of the movement prediction unit, the propagation change determination unit, and the selection unit is provided in the first control device, and
a unit other than a unit provided in the first control device among the movement prediction unit, the propagation change determination unit, and the selection unit is provided in the second control device.

### (Supplementary Note 1C)

A wireless control method including:
predicting a movement of a wireless terminal configured to perform wireless communication;
determining a propagation change degree indicating a degree of an extent that propagation of the wireless communication including received power of the wireless communication changes within a predetermined assumed delay time; and
selecting, from among a plurality of antennas and a plurality of beams, at least any of the antenna and the beam used for wireless communication control with the wireless terminal, based on the determined propagation change degree.

### (Supplementary Note 2C)

The wireless control method according to Supplementary Note 1C, further including:
when selecting at least any of the antenna and the beam,
receiving, from a propagation information storage unit configured to store information about the received power as propagation information, information about the received power for each of the antennas and each of the beams in a predicted position of the wireless terminal; and
selecting at least any of the antenna and the beam used for the wireless communication control with the wireless terminal, based on information about the received power for each of the antennas and each of the beams in a predicted position of the wireless terminal.

### (Supplementary Note 3C)

The wireless control method according to Supplementary Note 2C, further including:
when determining the propagation change degree,
determining the propagation change degree by calculating the propagation change degree; and
deciding, from the determined propagation change degree, whether selection control including addition and switching of the antenna and the beam is necessary.

### (Supplementary Note 4C)

The wireless control method according to Supplementary Note 2C, further including:
when determining the propagation change degree,
determining the propagation change degree by calculating the propagation change degree; and,
when selecting at least any of the antenna and the beam,
deciding, from the determined propagation change degree, whether selection control including addition and switching of the antenna and the beam is necessary.

### (Supplementary Note 5C)

The wireless control method according to any one of Supplementary Notes 1C to 4C, further including, when selecting at least any of the antenna and the beam, selecting at least any of the antenna and the beam used for the wireless communication with the wireless terminal.

### (Supplementary Note 6C)

The wireless control method according to any one of Supplementary Notes 1C to 4C, further including, when selecting at least any of the antenna and the beam, selecting at least any of the antenna and the beam used for wireless resource control with the wireless terminal.

### (Supplementary Note 7C)

The wireless control method according to any one of Supplementary Notes 1C to 6C, further including, when determining the propagation change degree, determining the propagation change degree from a relationship between the assumed delay time and a quality fluctuation time of the wireless communication.

### (Supplementary Note 8C)

The wireless control method according to Supplementary Note 7C, wherein the assumed delay time includes a time from a first timing at which information about the received power is received to a second timing at which the assumed delay time is updated in accordance with information about the received power being received next.

### (Supplementary Note 9C)

The wireless control method according to Supplementary Note 7C or 8C, wherein a quality fluctuation time of the wireless communication includes a time in which the received power decreases to equal to or less than a predetermined threshold value when a radio wave used for the wireless communication is blocked by a shield.

### (Supplementary Note 10C)

The wireless control method according to any one of Supplementary Notes 7C to 9C, wherein a quality fluctuation time of the wireless communication is calculated by dividing a width of a line-of-sight space of the radio wave by a movement speed of the wireless terminal.

### (Supplementary Note 11C)

The wireless control method according to Supplementary Note 10C, wherein a width of a line-of-sight space of the radio wave includes a Fresnel radius or diameter in a Fresnel zone from the wireless terminal.

### (Supplementary Note 12C)

The wireless control method according to any one of Supplementary Notes 1C to 11C, further including, when determining the propagation change degree, determining the propagation change degree from a relationship among the assumed delay time for each of the wireless terminals, information indicating a line-of-sight space of a radio wave used for the wireless communication, and predicted movement information about the wireless terminal.

### (Supplementary Note 13C)

The wireless control method according to any one of Supplementary Notes 1C to 12C, further including:
when determining the propagation change degree,
outputting the propagation change degree; and,
when predicting a movement of the wireless terminal,
updating a prediction of a movement of the wireless terminal, based on the output propagation change degree.

### (Supplementary Note 14C)

The wireless control method according to Supplementary Note 3C or 4C, further including:
when selecting at least any of the antenna and the beam,
selecting, when the selection control is necessary, at least any of the antenna and the beam, based on information about the received power for each of the antennas and each of the beams in a predicted position of the wireless terminal; and
selecting, when the selection control is unnecessary, at least any of the antenna and the beam, based on information about the received power of at least any of the antenna and the beam during communication.

### (Supplementary Note 15C)

The wireless control method according to any one of Supplementary Notes 1C to 14C, further including, when selecting at least any of the antenna and the beam, selecting, at a predetermined probability, at least any of the antenna and the beam being selected based on information about the received power for each of the antennas and each of the beams in a predicted position of the wireless terminal, and at least any of the antenna and the beam being selected based on information about the received power of at least any of the antenna and the beam during communication.

### (Supplementary Note 16C)

The wireless control method according to any one of Supplementary Notes 1C to 15C, further including, when predicting a movement of the wireless terminal, predicting a position and a speed of the wireless terminal, based on information about at least any of time series of position information about the wireless terminal, a movement history of the wireless terminal, and a map around the wireless terminal.

### (Supplementary Note 17C)

The wireless control method according to any one of Supplementary Notes 1C to 16C, further estimating a position of the wireless terminal.

### (Supplementary Note 18C)

The wireless control method according to Supplementary Note 17C, further including, when estimating a position of the wireless terminal, estimating a position of the wireless terminal, based on at least any of the propagation information, information about the received power, and arrival time information about a radio wave.

### (Supplementary Note 19C)

The wireless control method according to any one of Supplementary Notes 1C to 18C, further including, when selecting at least any of the antenna and the beam, selecting at least any of the antenna and the beam, based on a relationship among the received power predicted in the antenna and the beam to be a candidate of selection, a measurement value of the received power in the antenna and the beam during communication, and a predetermined threshold value of the received power.

### (Supplementary Note 20C)

The wireless control method according to any one of Supplementary Notes 1C to 19C, further including, when selecting at least any of the antenna and the beam, selecting at least any of the antenna and the beam, based on a plurality of positions from a current position of the wireless terminal to a predicted position.

### (Supplementary Note 21C)

The wireless control method according to any one of Supplementary Notes 1C to 20C, further including, when selecting at least any of the antenna and the beam, evaluating prediction accuracy by comparing a measurement value of the received power for each of the antennas and each of the beams being actually used for the wireless communication in a current position of the wireless terminal and a position in a movement history, with the received power for each of the antennas and each of the beams being predicted in each position, and then selecting at least any of the antenna and the beam.

### (Supplementary Note 22C)

The wireless control method according to any one of Supplementary Notes 1C to 21C, further including, when selecting at least any of the antenna and the beam, selecting at least any of the antenna and the beam with a plurality of predicted positions as candidates according to accuracy of position information.

### (Supplementary Note 23C)

The wireless control method according to any one of Supplementary Notes 1C to 22C, further including, when selecting at least any of the antenna and the beam, deciding the number of the antennas to be used simultaneously and the number of the beams to be used simultaneously according to a wireless resource usage rate.

### (Supplementary Note 24C)

The wireless control method according to any one of Supplementary Notes 1C to 23C, further including, when selecting at least any of the antenna and the beam, deciding a usage candidate of the antenna and the beam for a plurality of predicted positions, and selecting at least any of the antenna and the beam to be actually used from all candidates.

### (Supplementary Note 25C)

The wireless control method according to any one of Supplementary Notes 1C to 24C, further including, when selecting at least any of the antenna and the beam, inputting slice information for each of the wireless terminals and each piece of the wireless communication from a higher control device or a wireless base station device, and deciding whether selection control including addition and switching of the antenna and the beam is necessary, based on the slice information.

### (Supplementary Note 1D)

A wireless control program causing a computer to execute:
predicting a movement of a wireless terminal configured to perform wireless communication;
determining a propagation change degree indicating a degree of an extent that propagation of the wireless communication including received power of the wireless communication changes within a predetermined assumed delay time; and
selecting, from among a plurality of antennas and a plurality of beams, at least any of the antenna and the beam used for wireless communication control with the wireless terminal, based on the determined propagation change degree.

### (Supplementary Note 2D)

The wireless control program according to Supplementary Note 1D, further causing the computer to execute:
when selecting at least any of the antenna and the beam,
receiving, from a propagation information storage unit configured to store information about the received power as propagation information, information about the received power for each of the antennas and each of the beams in a predicted position of the wireless terminal; and
selecting at least any of the antenna and the beam used for the wireless communication control with the wireless terminal, based on information about the received power for each of the antennas and each of the beams in a predicted position of the wireless terminal.

### (Supplementary Note 3D)

The wireless control program according to Supplementary Note 2D, further causing the computer to execute:
when determining the propagation change degree,
determining the propagation change degree by calculating the propagation change degree; and
deciding, from the determined propagation change degree, whether selection control including addition and switching of the antenna and the beam is necessary.

### (Supplementary Note 4D)

The wireless control program according to Supplementary Note 2D, further causing the computer to execute:
when determining the propagation change degree,
determining the propagation change degree by calculating the propagation change degree; and,
when selecting at least any of the antenna and the beam,
deciding, from the determined propagation change degree, whether selection control including addition and switching of the antenna and the beam is necessary.

### (Supplementary Note 5D)

The wireless control program according to any one of Supplementary Notes 1D to 4D, further causing the computer to execute, when selecting at least any of the antenna and the beam, selecting at least any of the antenna and the beam used for the wireless communication with the wireless terminal.

### (Supplementary Note 6D)

The wireless control program according to any one of Supplementary Notes 1D to 4D, further causing the computer to execute, when selecting at least any of the antenna and the beam, selecting at least any of the antenna and the beam used for wireless resource control with the wireless terminal.

### (Supplementary Note 7D)

The wireless control program according to any one of Supplementary Notes 1D to 6D, further causing the computer to execute, when determining the propagation change degree, determining the propagation change degree from a relationship between the assumed delay time and a quality fluctuation time of the wireless communication.

### (Supplementary Note 8D)

The wireless control program according to Supplementary Note 7D, wherein the assumed delay time includes a time from a first timing at which information about the received power is received to a second timing at which the assumed delay time is updated in accordance with information about the received power being received next.

### (Supplementary Note 9D)

The wireless control program according to Supplementary Note 7D or 8D, wherein a quality fluctuation time of the wireless communication includes a time in which the received power decreases to equal to or less than a predetermined threshold value when a radio wave used for the wireless communication is blocked by a shield.

### (Supplementary Note 10D)

The wireless control program according to any one of Supplementary Notes 7D to 9D, wherein a quality fluctuation time of the wireless communication is calculated by dividing a width of a line-of-sight space of the radio wave by a movement speed of the wireless terminal.

### (Supplementary Note 11D)

The wireless control program according to Supplementary Note 10D, wherein a width of a line-of-sight space of the radio wave includes a Fresnel radius or diameter in a Fresnel zone from the wireless terminal.

### (Supplementary Note 12D)

The wireless control program according to any one of Supplementary Notes 1D to 11D, further causing the computer to execute, when determining the propagation change degree, determining the propagation change degree from a relationship among the assumed delay time for each of the wireless terminals, information indicating a line-of-sight space of a radio wave used for the wireless communication, and predicted movement information about the wireless terminal.

### (Supplementary Note 13D)

The wireless control program according to any one of Supplementary Notes 1D to 12D, further causing the computer to execute:
when determining the propagation change degree,
outputting the propagation change degree; and,
when predicting a movement of the wireless terminal,
updating a prediction of a movement of the wireless terminal, based on the output propagation change degree.

### (Supplementary Note 14D)

The wireless control program according to Supplementary Note 3D or 4D, further causing the computer to execute:
when selecting at least any of the antenna and the beam,
selecting, when the selection control is necessary, at least any of the antenna and the beam, based on information about the received power for each of the antennas and each of the beams in a predicted position of the wireless terminal; and
selecting, when the selection control is unnecessary, at least any of the antenna and the beam, based on information about the received power of at least any of the antenna and the beam during communication.

### (Supplementary Note 15D)

The wireless control program according to any one of Supplementary Notes 1D to 14D, further causing the computer to execute, when selecting at least any of the antenna and the beam, selecting, at a predetermined probability, at least any of the antenna and the beam being selected based on information about the received power for each of the antennas and each of the beams in a predicted position of the wireless terminal, and at least any of the antenna and the beam being selected based on information about the received power of at least any of the antenna and the beam during communication.

### (Supplementary Note 16D)

The wireless control program according to any one of Supplementary Notes 1D to 15D, further causing the computer to execute, when predicting a movement of the wireless terminal, predicting a position and a speed of the wireless terminal, based on information about at least any of time series of position information about the wireless terminal, a movement history of the wireless terminal, and a map around the wireless terminal.

### (Supplementary Note 17D)

The wireless control program according to any one of Supplementary Notes 1D to 16D, further causing the computer to execute estimating a position of the wireless terminal.

### (Supplementary Note 18D)

The wireless control program according to Supplementary Note 17D, further causing the computer to execute, when estimating a position of the wireless terminal, estimating a position of the wireless terminal, based on at least any of the propagation information, information about the received power, and arrival time information about a radio wave.

### (Supplementary Note 19D)

The wireless control program according to any one of Supplementary Notes 1D to 18D, further causing the computer to execute, when selecting at least any of the antenna and the beam, selecting at least any of the antenna and the beam, based on a relationship among the received power predicted in the antenna and the beam to be a candidate of selection, a measurement value of the received power in the antenna and the beam during communication, and a predetermined threshold value of the received power.

### (Supplementary Note 20D)

The wireless control program according to any one of Supplementary Notes 1D to 19D, further causing the computer to execute, when selecting at least any of the antenna and the beam, selecting at least any of the antenna and the beam, based on a plurality of positions from a current position of the wireless terminal to a predicted position.

### (Supplementary Note 21D)

The wireless control program according to any one of Supplementary Notes 1D to 20D, further causing the computer to execute, when selecting at least any of the antenna and the beam, evaluating prediction accuracy by comparing a measurement value of the received power for each of the antennas and each of the beams being actually used for the wireless communication in a current position of the wireless terminal and a position in a movement history, with the received power for each of the antennas and each of the beams being predicted in each position, and then selecting at least any of the antenna and the beam.

### (Supplementary Note 22D)

The wireless control program according to any one of Supplementary Notes 1D to 21D, further causing the computer to execute, when selecting at least any of the antenna and the beam, selecting at least any of the antenna and the beam with a plurality of predicted positions as candidates according to accuracy of position information.

### (Supplementary Note 23D)

The wireless control program according to any one of Supplementary Notes 1D to 22D, further causing the computer to execute, when selecting at least any of the antenna and the beam, deciding the number of the antennas to be used simultaneously and the number of the beams to be used simultaneously according to a wireless resource usage rate.

### (Supplementary Note 24D)

The wireless control program according to any one of Supplementary Notes 1D to 23D, further causing the computer to execute, when selecting at least any of the antenna and the beam, deciding a usage candidate of the antenna and the beam for a plurality of predicted positions, and selecting at least any of the antenna and the beam to be actually used from all candidates.

### (Supplementary Note 25D)

The wireless control program according to any one of Supplementary Notes 1D to 24D, further causing the computer to execute, when selecting at least any of the antenna and the beam, inputting slice information for each of the wireless terminals and each piece of the wireless communication from a higher control device or a wireless base station device, and deciding whether selection control including addition and switching of the antenna and the beam is necessary, based on the slice information.

The present disclosure is able to provide a wireless control device, a wireless communication system, a wireless control method, a wireless control program, and a storage medium that stores the related program that are able to achieve stable communication quality.

The first and second embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A wireless control device comprising:
a movement prediction unit configured to predict a movement of a wireless terminal configured to perform wireless communication;
a propagation change determination unit configured to determine a propagation change degree indicating a degree of an extent that propagation of the wireless communication including received power of the wireless communication changes within a predetermined assumed delay time; and
a selection unit configured to select, from among a plurality of antennas and a plurality of beams, at least any of the antenna and the beam being used for wireless communication control with the wireless terminal, based on the propagation change degree being determined by the propagation change determination unit.

2. The wireless control device according to claim 1, wherein the selection unit receives, from a propagation information storage unit configured to store information about the received power as propagation information, information about the received power for each of the antennas and each of the beams in a position of the wireless terminal being predicted by the movement prediction unit, and selects at least any of the antenna and the beam being used for the wireless communication control with the wireless terminal, based on information about the received power for each of the antennas and each of the beams in a predicted position of the wireless terminal.

3. The wireless control device according to claim 2, wherein the propagation change determination unit determines the propagation change degree by calculating the propagation change degree, and decides, from the determined propagation change degree, whether selection control including addition and switching of the antenna and the beam is necessary.

4. The wireless control device according to claim 2, wherein
the propagation change determination unit determines the propagation change degree by calculating the propagation change degree, and
the selection unit decides, from the propagation change degree being determined by the propagation change determination unit, whether selection control including addition and switching of the antenna and the beam is necessary.

5. The wireless control device according to claim 1, wherein the selection unit selects at least any of the antenna and the beam being used for the wireless communication with the wireless terminal.

6. The wireless control device according to claim 1, wherein the selection unit selects at least any of the antenna and the beam being used for wireless resource control with the wireless terminal.

7. The wireless control device according to claim 1, wherein the propagation change determination unit determines the propagation change degree from a relationship between the assumed delay time and a quality fluctuation time of the wireless communication.

8. The wireless control device according to claim 7, wherein the assumed delay time includes a time from a first timing at which information about the received power is received to a second timing at which the assumed delay time is updated in accordance with information about the received power being received next.

9. The wireless control device according to claim 7, wherein a quality fluctuation time of the wireless communication includes a time in which the received power decreases to equal to or less than a predetermined threshold value when a radio wave being used for the wireless communication is blocked by a shield.

10. The wireless control device according to claim 7, wherein a quality fluctuation time of the wireless communication is calculated by dividing a width of a line-of-sight space of the radio wave by a movement speed of the wireless terminal.

11. The wireless control device according to claim 10, wherein a width of a line-of-sight space of the radio wave includes a Fresnel radius or diameter in a Fresnel zone from the wireless terminal.

12. The wireless control device according to claim 1, wherein the propagation change determination unit determines the propagation change degree from a relationship among the assumed delay time for each of the wireless terminals, information indicating a line-of-sight space of a radio wave being used for the wireless communication, and predicted movement information about the wireless terminal.

13. The wireless control device according to claim 1, wherein
the propagation change determination unit outputs the propagation change degree, and
the movement prediction unit updates a prediction of a movement of the wireless terminal, based on the output propagation change degree.

14. The wireless control device according to claim 3, wherein the selection unit selects, when the selection control is necessary, at least any of the antenna and the beam, based on information about the received power for each of the antennas and each of the beams in a position of the wireless terminal being predicted by the movement prediction unit, and selects, when the selection control is unnecessary, at least any of the antenna and the beam, based on information about the received power of at least any of the antenna and the beam during communication.

15. The wireless control device according to claim 1, wherein the selection unit selects, at a predetermined probability, at least any of the antenna and the beam being selected based on information about the received power for each of the antennas and each of the beams in a position of the wireless terminal being predicted by the movement prediction unit, and at least any of the antenna and the beam being selected based on information about the received power of at least any of the antenna and the beam during communication.

16. The wireless control device according to claim 1, wherein the movement prediction unit predicts a position and a speed of the wireless terminal, based on information about at least any of time series of position information about the wireless terminal, a movement history of the wireless terminal, and a map around the wireless terminal.

17. The wireless control device according to claim 1, further comprising a position estimation unit configured to estimate a position of the wireless terminal.

18. The wireless control device according to claim 17, wherein the position estimation unit estimates a position of the wireless terminal, based on at least any of the propagation information, information about the received power, and arrival time information about a radio wave.

19. A wireless communication system comprising:
at least one wireless terminal; and
a wireless control device configured to perform wireless communication with the wireless terminal, wherein
the wireless control device includes
a movement prediction unit configured to predict a movement of the wireless terminal,
a propagation change determination unit configured to determine a propagation change degree indicating a degree of an extent that propagation of the wireless communication including received power of the wireless communication changes within a predetermined assumed delay time, and
a selection unit configured to select, from among a plurality of antennas and a plurality of beams, at least any of the antenna and the beam being used for wireless communication control with the wireless terminal, based on the propagation change degree being determined by the propagation change determination unit.

20. A wireless control method comprising:
predicting a movement of a wireless terminal configured to perform wireless communication;
determining a propagation change degree indicating a degree of an extent that propagation of the wireless communication including received power of the wireless communication changes within a predetermined assumed delay time; and
selecting, from among a plurality of antennas and a plurality of beams, at least any of the antenna and the beam being used for wireless communication control with the wireless terminal, based on the determined propagation change degree.
